(19) United States
(12) Patent Application Publication
(10) Pub. No.: US 2002/0103834 A1
(43) Pub. Date: Aug. 1, 2002

(54) Method and apparatus for analyzing documents in electronic form

(76) Inventors: James C. Thompson, Alexandria, VA (US); Jeff Maynard, Woodbridge, VA (US); Berne Dudley Robert, Alexandria, VA (US)

Correspondence Address: BANNER & WITCOFF, 1001 G STREET N W, SUITE 1100, WASHINGTON, DC, 20001, US

(21) Appl. No.: 09/891,496

(22) Filed: Jun. 27, 2001

Related U.S. Application Data
(60) Provisional application No. 60/214,482, filed on Jun. 27, 2000.

(51) Int. Cl. G06F 15/00

(52) U.S. Cl. 707/526

(57) ABSTRACT

A method of analyzing an electronic text document using a knowledge bank. The knowledge bank is formed of a plurality of lexicons. The analysis is conducted by defining for each of the lexicons an associated subject header and then defining a list of word terms having a logical relationship with the subject header. The document is then analyzed using the plurality of lexicons.

### REFERENCE TO RELATED APPLICATION

The present application claims priority to provisional application Serial No. 60/214,482 filed on Jun. 27, 2000 and entitled Method and Apparatus For Computer Aided Error Correction And Document Profiling., said application being incorporated herein by reference.

### BACKGROUND OF THE INVENTION

The present invention is generally directed to field of document review and analysis and more specifically is directed to a method and apparatus for analyzing documents in electronic form.

A number of document analysis systems are know in the prior art including well known techniques for “reading” a hard copy documents electronically and converting the text to electronic form. These so-called optical character recognition systems are in wide use today as a means of inputting hard copy documents into a computer system for editing. Such systems are limited in their analytical ability with respect to accurately reading the document characters and analyzing the document with respect to its content and the nature of the content. Accordingly, there is a vast need in the art for an improved system of electronic analysis of documents.

### BRIEF SUMMARY OF THE INVENTION

Accordingly, it is an overall object of the present invention to provide a method and apparatus for analyzing electronic documents.

It is a further object of the present invention to obviate the above-noted shortcomings and disadvantages of methods and apparatus for analyzing electronic documents known in the prior art.

A further object of the present invention is to provide an improved method and apparatus for analyzing electronic documents.

Another object of the present invention is to an provide an improved method and apparatus for analyzing electronic documents which can be easily and inexpensively implemented.

These another objectives of the present invention are achieved by the present invention as described below.

### BRIEF DESCRIPTION OF THE DRAWINGS

The novel features of the present invention are set out with particularity in the appended claims, but the invention will be understood more fully and clearly from the following detailed description of the invention as set forth in the accompanying drawings in which:

FIG. 1 illustrates an image to data processing system in accordance with the present invention;

FIG. 2 is a block diagram of the present invention;

FIGS. 3-11 are flow charts illustrating various embodiments of the present invention;

FIGS. 12-14 illustrate various word grouping in accordance with the present invention.

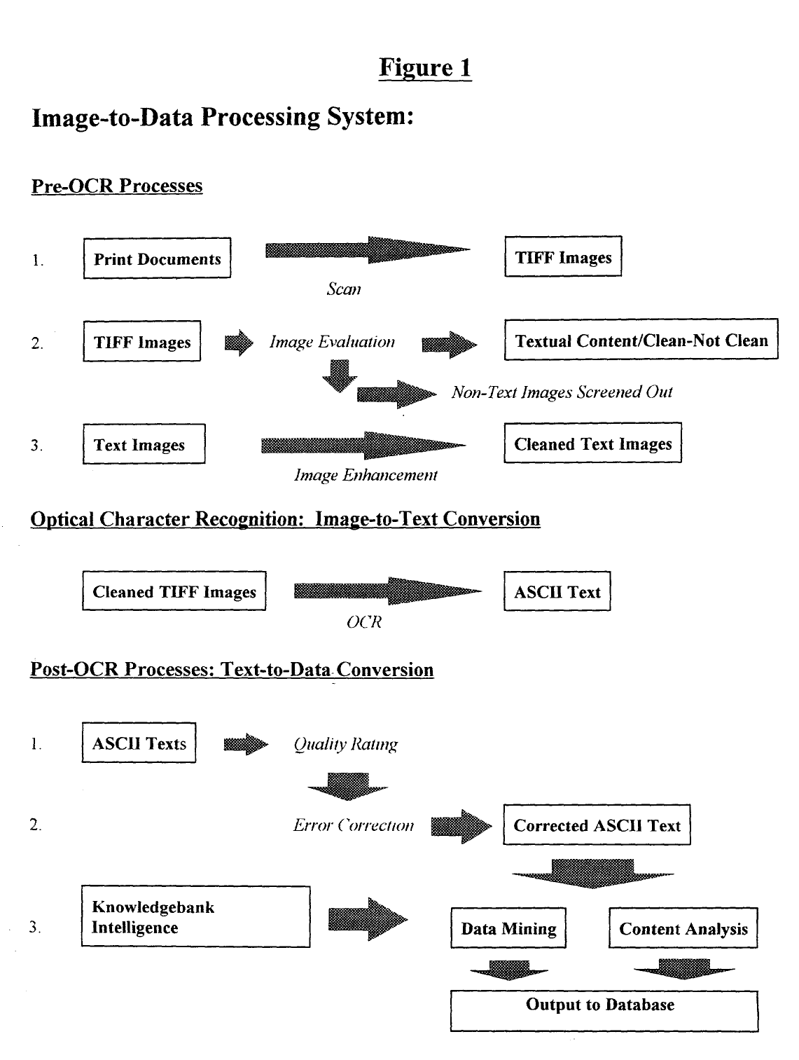

### BRIEF DESCRIPTION OF THE PREFERRED EMBODIMENT

For purposes of this discussion, a knowledgebank is a computerized repository of lexicons organized and stored in a hierarchical directory system similar to a library classification system. The e-card catalogue/knowledgebank is a similar repository of lexicons maintained specifically to upport computer-aided knowledge management activities in an e-commerce environment. When connected in this hierarchical form, these word sets become “intelligence” that can be harnessed to automate a variety of labor intensive data processing tasks. This intelligence has been applied to accomplish these tasks in computer-aided error correction applications including document quality rating, quality-based sorting, error location, error repair, and error documentation, in content analysis applications including document sorting, screening, characterizing, and abstracting, and computer-aided document profiling, and in data mining applications, including data mining, generic searching, and computer-aided non-standardized forms processing. These applications, and the utilities that support them, are described in the following pages.

Lower Order Intelligence and Higher Order Intelligence

E-card catalogue/knowledgebank lexicons are word sets that in some way belong to the lexicon's subject header, where “subject header” represents the name of the lexicon in its e-card catalogue category/sub-category. For example, a lexicon with the name “All Birds” would contain a list of all bird names. A lexicon with the name “Accounting Terms” would contain the list of all simple and complex terms meaningful in the practice of Accounting. A lexicon with the name “Non-disclosure Agreement” would contain terms found in a typical non-disclosure agreement.

The “All Birds” lexicon expresses “first level logic” in the sense that it establishes a logical relationship between this set of terms and the subject header “Bird Names”. This logical relationship is expressed in the proposition “x is a bird name” where “x” is a member of the set of “All Birds”. “Second level logic” is expressed by locating the “All Birds” lexicon under the subject category/sub-category “Living Creatures/Vertebrates—Feathered” in the sense that this establishes a logical relationship between this set of terms and the category/subcategory “Living Creatures/Vertebrates—Feathered” and in the sense that this establishes a relationship between the subject name “All Birds” and the category/subcategory “Living Creatures/Vertebrates-Feathered”.

In the same way, the “Accounting Terms” lexicon expresses first level logic by affirming that this set of terms has meaning in the practice of Accounting. Second level logic would be expressed by locating this lexicon in this subject category/sub-category “Business/Financial Record Keeping”. The “Non-Disclosure Agreement” lexicon expresses second level logic when it is placed in the e-card catalogue category/sub-category “Law/Legal Forms”. For the purpose of this discussion, this implies that the terms in the non-disclosure lexicon, taken as a set, relate to a particular legal function.

When terms are situated in lexicons and when these lexicons are situated in e-card catalogue/knowledgebank categories/sub-categories, they take on the “meaning” inherent in their first level and second level logical relationships. This allows them to be used in forming the logical inferences entailed in complex intelligence-requiring tasks such as text error correction, data mining, and content analysis. For purposes of this discussion, lower order intelligence is considered to be the functional capability of the computerized process to form first level logical relationships. Higher order intelligence is considered to be the functional capability of the computerized process to form second level logical relationships.

Meaning and Meaninglessness

According to Lewis Carroll, a snark is a boojum. This construction is syntactically valid and has a valid logical form in spite of the fact that neither “snark” nor “boojum” have meaning. For the purposes of this discussion, the terms “snark” and “boojum” are considered meaningless because 1) neither is a knowledgebank subject header and 2) neither is a member of a knowledgebank lexicon. The proposition “a snark is a boojum” is therefore meaningless because the logical relationship it expresses has no functional connections. Put another way, no other valid propositions can be formed. For example, “a snark is a Mediterranean lankmark” is not valid because “snark” is not a member of the “Mediterranean Lankmarks” lexicon. Nor is “a boojum is an impregnable fortress” valid because “boojum” is not a member of the “Impregnable Fortress” lexicon.

The proposition “a snark is a boojum” becomes meaningful, however, once “boojum” is made a member of the set of “Lewis Carroll Musings”. Being now a member of a lexicon with a subject header, the proposition “a snark is a boojum” expresses a valid first level logical relationship in the same way that the proposition “A massive rock is an impregnable fortress” does if “Gibraltar is a massive rock” and “Gibraltar is an impregnable fortress” are valid propositions.

Intelligence Defined in Terms of Automating Specified Data Processing Tasks

What distinguishes “boojum” from “Gibralter”, for purposes of this discussion, is that Gibraltar has many logically valid connecitons. “Gibraltar”, for example, is an “impregnable fortress”, a “Massive Rock” and a “Mediterranean Landmark”. That is to say, more first level logical relationships can be formed for “Gibralter” than for “boojum”. And by implication, more second level logical relationships can also be formed. It is therefore possible to make valid logical inferences, not only about “Gibraltar”, but about things related to “Gibraltar” in the context of its status as an “impregnable fortress” and as a “massive rock” and as a “Mediterranean landmark”. That is to say, it is also possible to form logically meaningful relationships between “impregnable fortress” and “massive rock”, between “massive rock” and “Mediterranean landmark”, and between “impregnable fortress” and “Mediterranean landmark”, among others.

In the same way, it is possible to form more logical relationships with “boojum”. This can be done by locating “boojum” in one or more higher level knowledge categories. For example, when “boojum” is entered into the set of “Whimsical Terms” and made a member of “Inventions of Lewis Carroll”, it gains meaning in the English Language in the same way “Gibralter” gains meaning when included among the sets of “Massive Rocks”, and “Mediterranean Landmarks”. In respect to the application of these terms in the logical system represented by the e-card catalogue/knowledgebank, it is irrelevant that “snark” and “boojum” have no material reality or denotations in the way Gibraltar does. They are equivalent in the relevant sense that they are terms in the nexus of the e-card catalogue/knowledgebank and can be used to perform practical data processing tasks:

1. Computer-aided Error Correction Applications use e-card catalogue/knowledgebank intelligence to distinguish between terms in a document that are valid and terms in that document that are not valid. Having sorted terms into these two categories, error correction algorithms can be applied to locate text error solutions in knowledgebank lexicons and to gauge the suitableness of these solutions according to the characteristics of the document in which the errors reside.

Configuring e-card catalogue/knowledgebank intelligence to conform with the characteristics of working documents improves the performance of the error correction process. For example, if a document is printed in the English language, the process will locate more correct “solutions” by referencing an English language dictionary as opposed to, for example, a German language dictionary. By the same token, if the document is about “Gibraltar”, the performance of the correction process will be enhanced if the intelligence available to the computer-aided error correction utility pertains to “Gibraltar” rather than to “whimsical terms.”

2. Content Analysis Applications involve characterizing documents by “type”, by “topic”, and by “critical content”. E-card catalogue/knowledgebank intelligence makes it possible to analyze document content by using first level logic as a means to characterize documents by “topic” and second level logic to characterize documents by “type”. For example, the “type” of a document whose lexicon is found to correlate with the “Non-disclosure Agreement” lexicon can be characterized as a “Law/Legal Form” which is the e-card catalogue sub-category. The document topic is “Non-Disclosure Agreement”, which is its subject header.

3. Data Mining Applications mine data from forms in non-standardized and documents in free text formats. Data mining is a two step process. The first step is to search documents for specified character sets. The second step is to copy these terms into the appropriate fields of a searchable output database. Non-standardized forms processing is a three-step process. The first step uses knowledgebank intelligence to pinpoint a document's type within a pre-defined set. Once the document's type has been established (for example, “form-type A”), the system can examine the document in terms of the character sets appropriate to “form-type A”. The third step in the data mining process is to copy them into the appropriate fields of a searchable output database.

Expanding System Intelligence

To fulfill its potential as a tool in cyber-commerce, the e-card catalogue/knowledgebank must be easily expandable and its intelligence must be assessable in the broadest sense of the word. The system therefore includes utilities to facilitate conversion of extraneous data into database formats used by error correction, content analysis, and data mining applications. Extraneous data might include, for example, lexicons downloaded from internet reference and other sites, user-developed keyword lists, indexes created from document in free text format, and pre-existing database records.

The e-card catalogue/knowledgebank is expanded by creating and naming new subject headers/sub-headers (directories/sub-directories) and by saving new lexicons (word sets) into these directories. Lexicons can be manufactured using the VocabularyBuilder utility to index, alphabetize and de-duplicate the words contained in converted texts. Because the VocabularyBuilder utility has its own embedded intelligence in the form of a common language dictionary which specifies parts of speech, users can manufacture lexicons with specified word types, or they can exclude value-neutral words such as conjunctions, prepositions, pronouns, and articles from their user-generated lexicons. The VocabularyBuilder utility also allows users to convert existing databases into compatible formats for inclusion into the e-card catalogue/knowledgebank.

E-card Catalogue/Knowledgebank Intelligence Interacts with Application-resident Intelligence

E-card catalogue/knowledgebank intelligence is necessary, though not sufficient for computer-aided error correction applications to identify invalid terms within working texts. Likewise, e-card catalogue/knowledgebank intelligence is necessary, though not sufficient for content analysis applications to identify document types and topics. In these applications intelligence in the e-card catalogue/knowledgebank is supplemented by intelligence resident in the applications.

Computer-aided error correction applications have resident intelligence in the form of four embedded reference databases: a commonly used word gazetteer, a first names gazetteer, a last names gazetteer, and a spell-checker that identifies other valid forms of root words. Application performance capabilities can be enhanced by supplementing resident intelligence with “technical” lexicons from the e-card catalogue/knowledgebank or from other extraneous sources. For example, if the document being processed deals with “accounting”, the system's resident intelligence can be supplemented with lexicons pertaining to “accounting” loaded from the e-card catalogue/knowledgebank, or perhaps, from an online reference gazetteer of accounting terms.

Content analysis applications compare lexicons of working documents with e-card catalogue/knowledgebank lexicons. System-resident instructions are used to calculate the level of similarity between the lexicons. The higher the content correlation between the lexicon of the working document and lexicons in the e-card catalogue/knowledgebank, the more likely it is that the working document pertains (in some way) the subject of the knowledgebank lexicons. For example, a document with a lexicon that correlates more closely to “Non-Disclosure Agreement” than to a “Hospital Admission Form” is more like to be a non-disclosure agreement than a hospital admission form. Based on the higher content correlation, computer-aided document profiling applications would identify the document type as “Law/Legal Form” and the document topic as “Non-disclosure Agreement”.

The first step in non-standardized forms processing is to identify the form's type from among a pre-established set of non- standardized forms or free-text documents. The non-standardized forms processing application accomplishes this identification by comparing the lexicons of working documents against the lexicons of the documents in the application's knowledgebank. The system makes its identifications on the basis of the similarities between these lexicons. That is to say, the document's type is identified as that form type whose lexicon has the highest content correlation value with the working document.

Content Correlation Values

Word sets comprising working documents are more or less similar to lexicons resident in the e-card catalogue/knowledgebank. For purposes of this discussion, similarity is considered to increase as the number of non-duplicated terms in two matched lexicons increases and as the number of non-duplicate terms in the same two lexicons decreases. Using this method for establishing the content correlation value between two lexicons, the highest possible correlation value is achieved when two lexicons contain an identical set of terms. Using this method, the lexicon of a document pertaining to the Rock of Gibralter would not have a high content correlation value with the lexicon of the Oxford English Dictionary even though every word in the “Gibraltar” document was found in the OED. The correlation would fall because the OED lexicon contains a vastly larger number of non-duplicated terms.

Simple Terms and Complex Terms

Lexicons contain simple terms and complex terms. For purposes of this discussion, simple” means “single, or “standing alone” and “complex” means “more than one” or “set”. Examples of simple terms are: “accounting”, “Gibraltar, “non-disclosure”, and “boojum”. Examples of complex terms are: “Alice in Wonderland”, “non-disclosure agreement”, “request for payment”, and “all whimsical terms”. Complex terms may carry a particular meaning or have “technical” significance. However, for purposes here, any combination of terms so designated can be a complex term.

E-Card Catalogue/Knowledgebank: A Dynamic Online Repository

E-card catalogue/knowledgebank is dynamic in the sense that it is, in theory, infinitely expandable. It is also dynamic in the sense that its intelligence is used to automate a variety of complex, labor-intensive data-processing tasks. It is also dynamic in the sense that the potential exists to apply the technology to automate a much broader set of operator-dependent data processing tasks than enumerated here. It is also dynamic in the sense that as an online repository, centralized, universally accessible, and uniquely suited to facilitate computerized knowledge management tasks, e-card catalogue/knowledgebank lexicons will ultimately become the standard for e-commerce “Intelligence”.

E-Card Catalogue/Knowledgebank Subject Categories (Illustrated)

Arts & Entertainment

Design

Leisure/Recreation

Literature

News

Sports

Business

Accounting

Advertising

Agriculture and Forestry

Business Services

Chemical

Colleges & Universities

Computers

Construction

Consulting

Defense

Design

Energy

Environment

Financial Services

Food & Related Products

Healthcare

Hospitality

Import/Export

Information Technology

Insurance

Internet

Legal

Maintenance

Manufacturing

Maritime

Medical Services

Mining & Drilling

News

Oil

Publishing

Real Estate

Retail

Science & Industry

Transportation

Telecommunications

Waste Management

Wholesale

Education

Continuing

Primary

Colleges & Universities

Secondary

Government

Communications

Defense

Education

Energy

Environment

Health

Occupational Health & Safety

Healthcare

Housing

Natural Resources

Science & Industry

Transportation

Reference

Hardcover

Library

Online

Science and Technology

Aerospace

Biology & Biotech

Chemical

Communications

Computer Science

Defense

Environment

Health

Information Technology

Medical & Life Sciences

Transportation

Telecommunications

Society and Culture

History

Literature

E-Card Catalogue Knowledgebank (Legal) Sub-Categories Illustration

Affidavits

Affidavit and Waiver of Right of Recission

Affidavit for Lost, Stolen, Destroyed Stock Certificate

Affidavit of No Lien

Affidavit of Nonpayment

Affidavit of Payment

Agreements

Agreement Between Owner And Contractor

Agreement For Extension Of Lease

Agreement for Permission to Sublet

Agreement Settling Boundary Line Dispute

Agreement to Compromise Debt

Agreement to Execute Lease

Agreement to Sell Business

Agreement to Sell Business Property

Agreement With Accountant

Antenuptial Agreement

Articles of Incorporation

Articles of Incorporation

Application For Reservation Of Corporate Name

Articles of Incorporation for a Not for Profit Organization

Articles Of Incorporation Of

Articles of Incorporation of Subchapter S Corporation

Assignments

Assignment and Transfer of Stock Certificate

Assignment of a Claim for Damages

Assignment of Accounts Receivable (With Recourse)

Assignment of Contract

Assignment of Contract for Purchase of Real Estate

Assignment of Contract to Sell Land

Assignment of Copyright

Assignment of Copyrights

Assignment of Deed of Trust

Assignment Of Entire Interest In Estate

Assignment of Income

Assignment of Lease

Assignment Of Lease By Lessee With Consent Of Lessor

Assignment of Lien

Assignment of Life Insurance Policy as Collateral

Assignment of Literary Property

Assignment of Money Due

Assignment of Mortgage

Assignment of Note

Assignment of Option to Purchase Real Estate

Assignment of Real Estate Purchase and Sale Agreement

Assignment of Receivable

Assignment of Rents by Lessor with Repurchase Agreement

Assignment of Security Interest

Assignment of Stock

Assignment of Stock Certificate

Assignment of Trademark

Notices

Notice Assignment of Debt

Notice by Seller of Commencement of Performance

Notice Delinquent Account

Notice Delinquent Account Turned over to Collections

Notice Non-payment of Rent

Notice of Additional Amounts Owed

Notice of Annual Meeting

Notice of Annual Meeting of Shareholders

Notice of Appeal

Notice of Breach of Warranty

Notice of Buyer's Disposition of Rightfully Rejected Goods

Notice of C.O.D.

Notice of Claim of Lien

Notice of Creditors—Partial Payment

Notice of Default

Notice of Defective Goods

Notice of Deposit Refund

Notice Of Deposition Subpoena For The Production Of Etc.

Notice of Dissolution (Partnership)

Notice of Election to Return

Notice Of Entry Of Judgment

Notice of Intention to Foreclose

Notice of Late Fee Owed

Notice of Lease

Notice of Meeting of Directors

Notice of Non-conforming Goods

Notice of NSF Check Charge and Late Fee Owed

Notice of Overdue Rent

Notice of Rejection of Goods

Notice Of Revocation Of Power Of Attorney

Notice of Right of Rescission

Notice of Special Meeting of Directors

Notice of Special Meeting of Shareholders

Notice Of Taking Deposition

Notice of Termination of Lease

Notice Of Transfer Of Reserved Name

Notice that Delivery will not be Made

Notice that Eviction will be Filed in Court

Notice to Accept Non-conforming Goods

Notice to Bank to Stop Payment on Check

Notice to Creditors—Payment in Full

Notice to Cure Violation of Agreement

Notice to Exercise Lease Option

Notice to Pay or Quit Tenancy

Notice to Person Executing Durable Power of Attorney

Notice to Terminate Tenancy at Will

Notice to Terminate Tenant-at-Will

Notice-Cancel Order

Notice-Disputed Balance

E-Card Catalogue Knowledgebank Lexicon (Non-Disclosure Agreement)

above

action

active

activities

address

advertisement

agency

agreement

agrees

alien

answers

any

applicant

application

apprenticeship

arises

attach

attended

attorney

available

basis

bearing

being

belonging

between

brief

business

carefully

civic

classification

company

complete

computer

confidential

consideration

contact

contingent

correct

cultural

date

depends

description

desired

dictation

discriminate

discriminatory

duties

educational

effect

employee

employer

employment

equal

event

execution

experience

facts

give

graduated

hardware

have

hereby

herein

history

included

information

introduction

justification

knowledge

leaving

legal

licenses

location

longer

machines

made

maintained

marital

military

misrepresentation

months

name

national

none

not

obligations

occupation

occurs

offices

omission

one

only

open

operated

opportunity

outside

parties

personnel

pertinent

phone

please

position

present

prevailing

previous

principal

printing

privy

professional

qualifications

reasonable

receipt

references

registration

related

reserve

salary

secret

secrets

security

sends

separate

separation

signature

signed

skills

social

software

special

starting

status

subject

supervisors

telephone

third

trade

training

treated

type

under

use

used

verification

who

words

worked

written

years

yes

zip

Pre-OCR and Post-OCR Processing

The “pre-OCR processing” and “post-OCR processing” technologies summarized below improve quality in optical character recognition (OCR) image-to-text conversions by 1) evaluating scanned *.tif images and determining if their content is suitable for optical character recognition image-to-text conversion, by 2) analyzing OCR'd text output in terms of its quality and error characteristics, and by 3) applying rules-based processes to resolve text errors introduced during image-to-text conversion.

The technologies summarized in the following pages can function independently and have considerable value as discrete tools. When combined with commercially available optical character recognition tools, they constitute a “system” that represents a substantial advance over unaided OCR conversion operators—from large image-to-text production facilities to users of desk-top scanning stations—to upgrade the quality of their output. The system accomplishes this by making determinations at critical points in the production cycle process by screening images for textual content prior to OCR conversion, by defining documents according to their quality characteristics, by implementing solutions according to a document's quality ratings and error characteristics, and by providing more efficient tools for residual error resolution.

Computer-aided Error Resolution Addresses Two Types of Failure

Computer-aided Error Resolution processes address two types of recognition failure:

1) Character Recognition Failure (CRF)

2) General Recognition Failure (GRF).

Character Recognition Failure (CRF)

For the purposes of this discussion, character recognition failure is a processing failure in which an optical character recognition algorithm, by incorrectly interpreting image data, introduces an invalid character into a text. omputer-aided Error Resolution treats character recognition failures in the context of the terms in which they reside. For purposes of this discussion, a “term” is defined to be one or more characters combined together in discreet set. For example “apothecary” is a “term”. A “word” is defined as a character set that resides in a user-specified reference database. When “apothecary” resides in a user-specified database, it is a “word”. An “non-word” is defined as a character set that does not reside in a specified reference database. “Apoth˜cary” would be a non-word term if it does not exist in the user-specified dictionary. Non-word terms that contain a majority of alpha characters are considered to be “exceptions”. “Ap˜th˜cary” is therefore and “exception”. Non-words that contain a majority of non-alpha characters are considered to be “trash”. “˜˜˜˜˜ecary” is therefore considered to be trash.

Computer-aided Error Resolution processes that treat character recognition failures are run in post-OCR processing.

General Recognition Failure (GRF).

When the trash in a textual documents is extensive enough, a document becomes unusable as “text”. For the purposes of this discussion, this defines general recognition failure. General recognition failure may occur because: 1) the content of a processed image is not specifically text, or because 2) the quality of an image that contains text is inadequate to support satisfactory optical character recognition.

The technical process used to determine whether an image contains textual material is call image screening. Image screening is a pre-OCR process.

Images of textual documents may be of insufficient quality to support satisfactory image-to-text conversion. The technical process that is used to improve image quality is called image enhancement. Image enhancement is also a pre-OCR process.

Pre-OCR Processing

Image Evaluation

The image evaluation method analyzes image content. This is valuable, among other reasons, for determining whether image content is suitable for automated recognition (image-to-text) conversion.

The image evaluation method is based on the empirically verifiable evidence that textual content in scanned images exhibits data characteristics that allow it to be distinguished from non-textual content. These data characteristics can be quantified in terms of:

1) image object aspect ratios (textual objects fall within a statistical grouping)

2) image object widths (textual objects that of unusual width suggest merged or touching characters)

3) image object density (textual objects fall within a statistical grouping)

4) vertical and horizontal spacing (these linear configurations are characteristics of text regions)

5) overlapping fragments (images with higher presences of overlapping components may contain graphic content or stray marks characteristic of poorly presented textual content)

6) horizontal groupings (this linear configuration is characteristic of text regions)

7) spacing of image objects in horizontal groupings (this linear configuration is characteristic of text regions and is a consideration in successful optical character recognition image-to-text conversion)

8) slope of horizontally grouped image objects (this linear configuration is characteristic of text regions and is a consideration in successful optical character recognition image-to-text conversion)

9) margins (this linear configuration is characteristic of text regions and can reveal image skewing and other scanned impairments)

10) “stray” marks and image “noise” (image objects that are less than a certain width and density and that are not in discernable linear settings are likely to be non-textual particles that will impair image-to-text conversion)

11) abstract qualities (image objects that are text have regular curves, discreet linear patterns, and holes of significant)

12) edge quality (image objects that are text have smooth edges. Fuzzy edges impacts quality in image-to-text conversion)

Measurement parameters are dependent upon the operating tolerances of the recognition process used. Individual values can be adapted to the requirements of particular optical character recognition image-to-text conversion applications.

The image evaluation method quantifies an image's data in terms of these characteristics of textual content. The more distinctively these characteristics are expressed, the more likely it is that the image contains textual content. In this way, the image evaluation method rates the suitability of images for optical character recognition image-to-conversion. The method also provides statistical criteria for determining whether image enhancement and cleaning are appropriate prior to optical character recognition image-to-text conversion.

The statistical information developed by the image evaluation method is analyzed in terms of a statistical norm. Objects larger than that norm tend to be graphics and abstract symbols that have high potential for optical character recognition failure. Objects smaller objects than the established norm may be punctuation or “noise”. These also represent high potential areas for optical character recognition failure. These failures can be minimized through image cleaning and image enhancement techniques.

The Process Summarized

The method's analytical process begins by converting a scanned image into raster format. This raster image data is then presented for “input” using a specialized video process. (This input process is defined below under “Improved Method of Image Preprocessing”) This input process creates a coordinate map of all image data and gathers information about patterns in these data items. In addition to information about location, this input process extracts information relating to object size, aspect ratio, and “ink” density. When all the image's data items have been mapped, coordinates for the top left and bottom right pixels are recorded in a database table to define the image's data field. Coordinates can also be identified defining data “communities” within the image's data field.

Once the information about the image's individual data items have been recorded, the process analyzes the data to identify data “clusters” (or blobs). Average height and width of these image “objects” are then calculated.

Information developed in this process can be used to determine if the image is skewed and to gauge the image quality. For purposes of this discussion, image quality is a measurement of data characteristics relative to requirements for successful optical character recognition. That is to say, to what extend do the image objects in the image's particular data communities have characteristics of text, and to what extend do these image objects have characteristics of “readable” text. Considerations relating to “readability” include the amount of variation in object width, the number of “joined characters”, the number of “problem lines”, the characteristics of the “holes” in the image objects, the number of “specks” in the data fields, and image resolution.

By measuring the verticality, the noise, the character definition, average distance between objects and the object density, the image evaluation method is able to characterize images in terms of textual content and in terms of quality relative to optical character recognition image-to-text conversion.

“Numeric Arrays” and “Data Patterns”

For purposes of this discussion, images in raster format are “numeric arrays”. Objects in the image can also be characterized as numeric arrays.

Having characterized an image's content as textual, the image evaluation method applies a process called “pre-process expansion” to order its numeric arrays into lines and to separate these lines into segments of (8) pixel “bytes”. Each byte functions as an index of critical information. Taken in expanding sets, these indexes describe the “objects” in the image and the “data patterns” in which these objects relate to one another. Taken in entirety they constitute a data map of the image.

These indexes show whether a pixel contains data or is an empty space, whether the neighboring pixels in its raster line contain data or are empty spaces, and whether pixels above, below and adjacent to it in preceding and succeeding raster lines contain data or whether they are empty spaces.

For purposes of this discussion, each pixel is in relationship with several other pixels:

| | | | | | |
|---|---|---|---|---|---|
| In line 1 | [pixel] | | [pixel] | | [pixel] |
| | | -R3- | -R4- | -R4- | |
| In line 2 | [pixel] | -R1- | [pixel] | -R2- | [pixel] |
| | | -R5- | -R6- | -R7- | |
| In line 3 | [pixel] | | [pixel] | | [pixel] |

The relationship of centered pixel to its contiguous pixels are as follows: R1=same line/left relationship; R2=same line/right relationship; R3=preceding line/adjacent left relationship; R4=preceding line/above relationship; R5=preceding line/adjacent right relationship; R6=succeeding line/adjacent left relationship; succeeding line/below relationship; R7=succeeding line/adjacent right relationship.

If the centered pixel contains data, the pre-process expansion process assigns a value of (9) in its “byte index”. If it does not contain data it is assigned a value of (0). The valuation of the pixels in the remaining relationships is described in the technical summary that follows.

Image Evaluation Supports Other Pre-OCR Processes

Information developed in the image evaluation process is useful for other pre-OCR processing purposes:

1) Auto-Zoning The same processes used to determine that an image has textual content can be applied to distinguish the areas image an which have textual content from the areas in the image which do not have textual content. Having defined these areas, this information can be characterized in instructions to optical character recognition applications such that optical character recognition is performed on areas of the image where the textual content resides and not on the areas of the image that do not have textual content.

2) Image Cleaning Having determined data objects in an image have characteristics of text, and having determined that some amount of the data in the image's textual content zones is “noise”, and having determined the location of this noise relative to the prospective textual objects, standards can be created to determine the “cleanness” of images and following these standards, the system can send “unclean” images to other processes for removal of excess noise, straightening edges, sharpening image contrast, and other routines that enhance images for image-to-text optical character recognition conversion.

3) De-Skewing Information developed in the image evaluation method is also valuable for determining the alignment of the textual context of an image relative to vertical and horizontal axes. This provides a basis for “de-skewing” the image prior to image-to-text conversion.

Applying Image Evaluation

The image evaluation method can be contrasted with two commonly used image-to-text conversion processes:

Scenario I: In this scenario, image content and quality are not considered before image-to-text conversion.

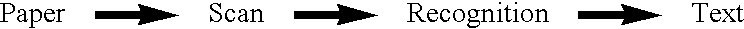

Scenario II: In this scenario the quality of the image-to-text conversion is improved because operators visually inspect images to screen out poor quality sheets, and sheets that have non-textual content. This improvement is accomplished at the expense of higher production costs, lower productivity, and longer turn around times.

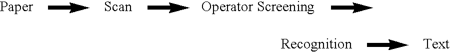

Scenario III: The image evaluation scenario represents an improvement over Scenarios I and II because it does not need an operator to implement crucial processing instructions, and because the processes it implements are based on objective standards relating to image content and image quality. It is therefore less expensive and less time consuming to produce higher quality textual output.

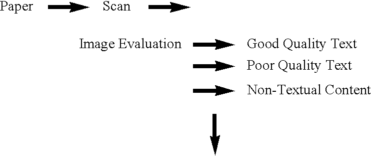

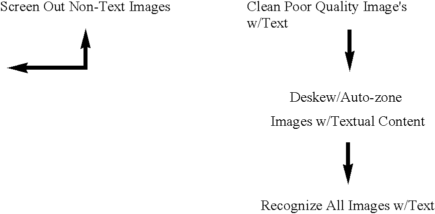

An Improved Method of Image Preprocessing

The Improved Method of Image Preprocessing looks at document images line by line and gathers information about the “ink” patterns. These patterns are referred to as ‘blobs’. It tracks each ink blob encountered on each new image line keeping track of blobs that are connected to, on the previous line. Some blobs are new, when it is determined that a new blob is encountered then the process gives this a fragment id number. Some blobs are connected in successive lines. When two blobs of different id numbers are determined to connect then the id numbers are changed for one of the blobs to indicate that these are now one big blob.

As each line is examined and ink is encountered the corresponding fragment's data structure is adjusted to indicate it has been ‘hit’. Other values in the fragment's data structure are adjusted also. These values are the positional information and other qualities deemed useful to the various connected process in the Evaluation method and error correction processes in this document. It also saves the actual pattern of the ink found in the image. This is used in conjunction with he Interactive Recognition process as described in the evaluation section.

This description refers to an image as a numeric array of numbers representing an ink object on a paper background. The ink object need not originally be black ink and white paper. It represents contrasting image components. The notation here is hexadecimal, a common data processing notation for base 16.

A Raster line is examined first by a process called Preprocessor expansion. This process segments the raster line into manageable segments. For this discussion the segments are 8 pixels in size. Each segment or byte is used as an index in a table that has been previously constructed to indicate whether or not a pixel is representing ink or not. It also indicates if an adjacent pixel is ink or not. This method is as follows.

There are three array systems. Each system of arrays contain the same number of corresponding digits. The first array is a single array of binary information. This is a pixel for binary digit representation for the image information. The next array system is the Expanded Preprocessor system. This represents a single digit from the image information with a single hexadecimal digit in the Expanded preprocessor array. Finally there is an array of fragment id data. This array maintains a numeric digit for the fragment id element with corresponding value in the expanded preprocessor array. The expanded preprocessor array and the fragment id data array have corresponding arrays, for the current line and the previous line of examined image information.

In some cases the image information line can be the actual image information from a shared data structure in a related or concurrent process, to save the memory and the time used to load the data. There can also be another image array the is used to convert color or gray representation schemes when other than black and white or line art images are utilized.

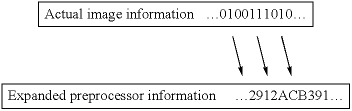

If a pixel is ink it is given a value of 9 if not it has a value of 0. if one of the pixels adjacent is ink the value is added to by 1 if the other pixel is ink, it is increased by 2. a blank pixel by its self has a value of 0. A blank pixel adjoining an ink pixel is either 1 or 2 depending on the bias consistently implied by the program. It it lies between two pixels it's value is three. An ink pixel by its self is 9 if either pixel is ink adjacent to it its value is either A or B following the afore mentioned convention. If both are ink, then its value is C. in this manner a pixel now can indicate if it is touching another ink pixel or not and on which side.

The figure demonstrates the carry over and under of adjoing bytes. The same rule above applies but it is preformed on the next and previous bytes

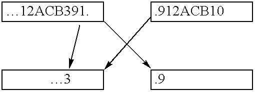

The following figure demonstrates the relationship between the current and previous expanded preprocessor and the fragment id data array.

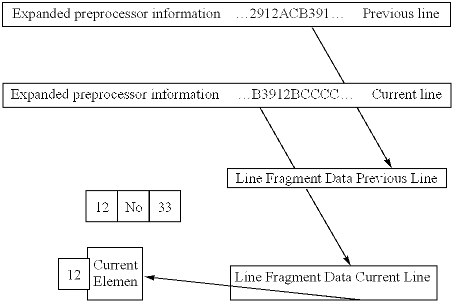

After each line is loaded into its preprocessor array it is compared to the previous lines preprocessed data. By examining the ink pixels from the previous line and the previously examined pixel, ink in the image can be tracked. As ink is encountered, it is marked in a array by a fragment number. When previous ink fragments are encountered that are adjoined to new ink, the information about the position is used to update the fragment's accumulative data, such as the row and column and number of pixels associated with the fragment. In addition to the numeric information the image of the ink fragment is included in the fragments data structure. The figure shows fragment 1 and 2 meeting and becoming a complex fragment 1

Fragment Id arrays history

..00111000000002222220000..
..00110000000000222200000..
..00011111111111111000000..

When fragments run into each other as the course of scanning continues, the fragments' information and ink image are combined. While the size in pixels is a simple matter of addition, the starting and end points are carefully compared to find the appropriate value. For instance the new starting point would be the lesser of the to, and the end point would be the greater of the to. One fragment chosen arbitrarily is deleted and the updated information is assigned to the other. The image information is mapped together as to reflect the actual image of the ink's appearance.

At the end of each line examination the fragments are checked, if they have had any activity or any subordinate fragment has had any additions made during that video line then the fragment is complete and is archived for later evaluation, in the post preprocessing phase. The image information is optimized for storage using a commercially available image compression product standard.

Subordinate fragments happen when the information about a fragment combining with its self or another fragment indicates the shape of the fragment might be complex. This allows for evaluation of the abstract shape of an ink object. Figures could have complex fragmentation as apposed to printed characters that are relatively simple. One abstract measure is genus

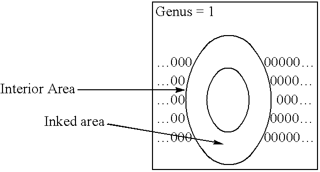

Genus is a topological measurement. It measures abstractly how many holes an object has. The genus of an object can be helpful in determining the nature of an ink object. If it has a genus of 0 then there are no relevant holes on the object. The letter I f x and w all have a genus of 0, o 4, 6 p r a D and d have a genus of 1. the image of the letters B 8 g have a genus of 2. while have a certain genus value doesn't specifically identify a character, it certainly can tell you if it is not a character that a standard recognition process will understand. A persons cursive signature could be one complete ink object and could have a genus greater than three. This combined with the over all size and density of ink pixel with respect to the area, would allow an automatic means to determine that recognizable qualities of an ink object.

Table A

This table is 256 indexes of 8 four bit hexadecimal numbers. The 256 indexes are directly related to the extents of a binary number of 8 digits.

Each of the corresponding hexadecimal numbers are related to the indexes bits in the following manner If the bit in question is asserted (a 1) then the corresponding initial hexadecimal value is equal to nine.

If the bit in question is negated (a 1) then the corresponding initial hexadecimal value is equal to nine.

To the initial value the value of 1 (one) is added if the next lower bit in question is asserted

To the initial value the value of 2 (two) is added if the next higher bit in question is asserted Note that the order of the hexadecimal digits is not sequential but follows the ordering sequence of 21436587. this is due to the way the intel microprocessors Store internally the type of 32bit integer. A different processing platform would have a corresponding relationship. Coding in this fashion removes a intermediate translation step in the processing of the video, unsigned int quick_map[256]={ //21436587 is the pixel or bit order hierarchy this would be translated for a different native 0x00000000, 0x19000000, 0x92010000, 0xAB010000, 0x20190000, 039190000, 0xB21A0000, 0xCB1A0000, 0x00920100, 0x19920100, 0x92930100, 0xAB930100, 0x20AB0100, 0x39AB0100, 0xB2AC0100, 0xCBAC0100, 0x00201900, 0x19201900, 0x92211900, 0xAB211900, 0x20391900, 0x39391900, 0xB23A1900, 0xCB3A1900, 0x00B21A00, 0x19B21A00, 0x92B31A00, 0xABB31A00, 0x20CB1A00, 0x39CB1A00, 0xB2CC1A00, 0xCBCC1A00, 0x00009201, 0x19009201, 0x92019201, 0xAB019201, 0x20199201, 0x39199201, 0xB21A9201, 0xCB1A9201, 0x00929301, 0x19929301, 0x92939301, 0xAB939301, 0x20AB9301, 0x39AB9301, 0xB2AC9301, 0xCBAC9301, 0x0020AB01, 0x1920AB01, 0x9221AB01, 0xAB21AB01, 0x2039AB01, 0x3939AB01, 0xB23AAB01, 0xCB3AAB01, 0x00B2AC01, 0x19B2AC01, 0x92B3AC01, 0xABB3AC01, 0x20CBAC01, 0x39CBAC01, 0xB2CCAC01, 0xCBCCAC01, 0x00002019, 0x19002019, 0x92012019, 0xAB012019, 0x20192019, 0x39192019, 0xB21A2019, 0xCB1A2019, 0x00922119, 0x19922119, 0x92932119, 0xAB932119, 0x20AB2119, 0x39AB2119, 0xB2AC2119, 0xCBAC2119, 0x00203919, 0x19203919, 0x92213919, 0xAB213919, 0x20393919, 0x39393919, 0xB23A3919, 0xCB3A3919, 0x00B23A19, 0x19B23A19, 0x92B33A19, 0xABB33A19, 0x20CB3A19, 0x39CB3A19, 0xB2CC3A19, 0xCBCC3A19, 0x0000B21A, 0x1900B21A, 0x9201B21A, 0xAB01B21A, 0x2019B21A, 0x3919B21A, 0xB21AB21A, 0xCB1AB21A, 0x0092B31A, 0x1992B31A, 0x9293B31A, 0xAB93B31A, 0x20ABB31A, 0x39ABB31A, 0xB2ACB31A, 0xCBACB31A, 0x0020CB1A, 0x1920CB1A, 0x9221CB1A, 0xAB21CB1A, 0x2039CB1A, 0x3939CB1A, 0xB23ACB1A, 0xCB3ACB1A, 0x00B2CC1A, 0x19B2CC1A, 0x92B3CC1A, 0xABB3CC1A, 0x20CBCC1A, 0x39CBCC1A, 0xB2CCCC1A, 0xCBCCCC1A, 0x00000092, 0x19000092, 0x92010092, 0xAB010092, 0x20190092, 0x39190092, 0xB21A0092, 0xCB1A0092, 0x00920192, 0x19920192, 0x92930192, 0xAB930192, 0x20AB0192, 0x39AB0192, 0xB2AC0192, 0xCBAC0192, 0x00201992, 0x19201992, 0x92211992, 0xAB211992, 0x20391992, 0x39391992, 0xB23A1992, 0xCB3A1992, 0x00B21A92, 0x19B21A92, 0x92B31A92, 0XABB31A92, 0x20CB1A92, 0x39CB1A92, 0xB2CC1A92, 0xCBCC1A92, 0x00009293, 0x19009293, 0x92019293, 0xAB019293, 0x20199293, 0x39199293, 0xB21A9293, 0xCB1A9293, 0x00929393, 0x19929393, 0x92939393, 0xAB939393, 0x20AB9393, 0x39AB9393, 0xB2AC9393, 0xCBAC9393, 0x0020AB93, 0x1920AB93, 0x9221AB93, 0xAB21AB93, 0x2039AB93, 0x3939AB93, 0xB23AAB93, 0xCB3AAB93, 0x00B2AC93, 0x19B2AC93, 0x92B3AC93, 0xABB3AC93, 0x20CBAC93, 0x39CBAC93, 0xB2CCAC93, 0xCBCCAC93, 0x000020AB, 0x190020AB, 0x920120AB, 0xAB0120AB, 0x201920AB, 0x391920AB, 0xB21A20AB, 0xCB1A20AB, 0x009221AB, 0x199221AB, 0x929321AB, 0xAB9321AB, 0x20AB21AB, 0x39AB21AB, 0xB2AC21AB, 0xCBAC21AB, 0x002039AB, 0x192039AB, 0x922139AB, 0xAB2139AB, 0x203939AB, 0x393939AB, 0xB23A39AB, 0xCB3A39AB, 0x00B23AAB, 0x19B23AAB, 0x92B33AAB, 0xABB33AAB, 0x20CB3AAB, 0x39CB3AAB, 0xB2CC3AAB, 0xCBCC3AAB, 0x0000B2AC, 0x1900B2AC, 0x9201B2AC, 0xAB01B2AC, 0x2019B2AC, 0x3919B2AC, 0xB21AB2AC, 0xCB1AB2AC, 0x0092B3AC, 0x1992B3AC, 0x9293B3AC, 0xAB93B3AC, 0x20ABB3AC, 0x39ABB3AC, 0xB2ACB3AC, 0xCBACB3AC, 0x0020CBAC, 0x1920CBAC, 0x9221CBAC, 0xAB21CBAC, 0x2039CBAC, 0x3939CBAC, 0xB23ACBAC, 0xCB3ACBAC, 0x00B2CCAC, 0x19B2CCAC, 0x92B3CCAC, 0xABB3CCAC, 0x20CBCCAC, 0x39CBCCAC, 0xB2CCCCAC, 0xCBCCCCAC

TABLE B
This is another example of table level
unsigned int quick_count[256] =
{// count of all asserted bits found in a 8 bit byte
0×00, 0×01, 0×01, 0×02, 0×01, 0×02, 0×02, 0×03,
0×01, 0×02, 0×02, 0×03, 0×02, 0×03, 0×03, 0×04,
0×01, 0×02, 0×02, 0×03, 0×02, 0×03, 0×03, 0×04,
0×02, 0×03, 0×03, 0×04, 0×03, 0×04, 0×04, 0×05,
0×01, 0×02, 0×02, 0×03, 0×02, 0×03, 0×03, 0×04,
0×02, 0×03, 0×03, 0×04, 0×03, 0×04, 0×04, 0×05,
0×02, 0×03, 0×03, 0×04, 0×03, 0×04, 0×04, 0×05,
0×03, 0×04, 0×04, 0×05, 0×04, 0×05, 0×05, 0×06,
0×01, 0×02, 0×02, 0×03, 0×02, 0×03, 0×03, 0×04,
0×02, 0×03, 0×03, 0×04, 0×03, 0×04, 0×04, 0×05,
0×02, 0×03, 0×03, 0×04, 0×03, 0×04, 0×04, 0×05,
0×03, 0×04, 0×04, 0×05, 0×04, 0×05, 0×05, 0×06,
0×02, 0×03, 0×03, 0×04, 0×03, 0×04, 0×04, 0×05,
0×03, 0×04, 0×04, 0×05, 0×04, 0×05, 0×05, 0×06,
0×03, 0×04, 0×04, 0×05, 0×04, 0×05, 0×05, 0×06,
0×04, 0×05, 0×05, 0×06, 0×05, 0×06, 0×06, 0×07,
0×01, 0×02, 0×02, 0×03, 0×02, 0×03, 0×03, 0×04,
0×02, 0×03, 0×03, 0×04, 0×03, 0×04, 0×04, 0×05,
0×02, 0×03, 0×03, 0×04, 0×03, 0×04, 0×04, 0×05,
0×03, 0×04, 0×04, 0×05, 0×04, 0×05, 0×05, 0×06,
0×02, 0×03, 0×03, 0×04, 0×03, 0×04, 0×04, 0×05,
0×03, 0×04, 0×04, 0×05, 0×04, 0×05, 0×05, 0×06,
0×03, 0×04, 0×04, 0×05, 0×04, 0×05, 0×05, 0×06,
0×04, 0×05, 0×05, 0×06, 0×05, 0×06, 0×06, 0×07,
0×02, 0×03, 0×03, 0×04, 0×03, 0×04, 0×04, 0×05,
0×03, 0×04, 0×04, 0×05, 0×04, 0×05, 0×05, 0×06,
0×03, 0×04, 0×04, 0×05, 0×04, 0×05, 0×05, 0×06,
0×04, 0×05, 0×05, 0×06, 0×05, 0×06, 0×06, 0×07,
0×03, 0×04, 0×04, 0×05, 0×04, 0×05, 0×05, 0×06,
0×04, 0×05, 0×05, 0×06, 0×05, 0×06, 0×06, 0×07,
0×04, 0×05, 0×05, 0×06, 0×05, 0×06, 0×06, 0×07,
0×05, 0×06, 0×06, 0×07, 0×06, 0×07, 0×07, 0×08,
};

};

Image Enhancement

For purposes of this discussion “image enhancement” refers to commercially available tools and technical processes that serve to improve the quality of scanned images such that optical character recognition image-to-text conversion might be more successfully performed. These technologies are not subject to claims in this patent document.

Optical Character Recognition

For the purposes of this discussion, optical character recognition is a utility that can be configured to meet the specifications of Computer-aided Error Resolution systems using commercially available tool-kits.

Image Enhancement

For purposes of this discussion “image enhancement” refers to commercially available tools and technical processes that serve to improve the quality of scanned images such that optical character recognition image-to-text conversion might be more successfully performed. These technologies are not subject to claims in this patent document.

Optical Character Recognition

For the purposes of this discussion, optical character recognition is a utility that can be configured to meet the specifications of Computer-aided Error Resolution systems using commercially available tool-kits.

Computer-aided Error Resolution

Post-OCR Computer-aided Error Resolution is a six step process:

1. The system employs sophisticated “matching” procedures in conjunction with a network of user-selected reference dictionaries to

a) identify terms in working text files that are “exceptions”

b) determine document quality based on the number of valid terms relative to the total number of terms in the document.

2. The system screens documents for processing suitability based on a user-specified text quality standards.

3. The system evaluates each exception and characterizes the error it represents as one of the following:

a) merged term

b) fragmented term

c) term with one invalid character

d) term with more than one invalid characters

e) misspelling

f) term with a combination of these errors.

4. The system applies its error correction algorithms to determine if an exception corresponds to one or more valid terms in the system's reference dictionaries.

5. The system assigns a confidence value to possible solutions generated by its error correction algorithms and an “error reduction factor” based on the error characteristics and the quality rating of the document.

6. The system globally corrects the text according to instructions provided by the user.

Indexing

The first step of the error correction process is to index user-selected working documents. To “index” a working document, for the purposes of this discussion, is to convert it into an alphabetized, de-duplicated list of the terms it contains.

Identifying Exceptions: “Invalid” Terms, “Non-validated” Trms, and Trash

Having converted the user-selected working documents into indexes, the system compares terms in these indexes with the terms in the user-selected reference dictionaries and automatically eliminates terms that exist in both data sets. Having reduced the number of terms in the index with this initial matching process, the system proceeds to spell-check the terms that remain in the index to determine whether any of these are non-root forms of valid words, such as plurals and past tenses. These terms are likewise eliminated from the index. Terms that are left after these two screening processes are either exceptions or trash. Exceptions may be either

1) “invalid terms”, meaning that they contain a majority of alpha characters and that they exhibit characteristics of known error types.

or

2) “non-validated terms”, meaning that they contain all-alpha terms, but do not reside in the user-selected reference dictionaries.

For purposes of this discussion, invalid terms that have less than 50% alpha characters are considered trash.

Document Quality Ratings

The system assigns a “quality rating” to each working document. This quality rating is calculated by dividing the number of words by the total number of terms in the document. For example, if a document contains 1000 terms and 925 are identified as words-including proper names, then the quality value of the document is 0.925. If a document has 1000 terms and 700 are identified as words-including proper names, the quality value of the document is 0.70.

Document Quality Ratings as a Process Screening Tool

At some point the quality of a document falls below a minimum functional standard to be usable. The system allows users to decide this standard on a case by case basis. If, for example, a user sets the standard at 75 he instructs the system to process documents with a minimum of 75% valid terms (i.e., words and proper names). Stated the other way, the user instructs the system not to process documents in which more than 25% of the terms are invalid.

The Computer-aided Error Resolution system further distinguishes invalid terms (i.e., non-words) as exceptions, meaning terms with a majority of alpha characters, and trash, meaning terms with a majority of non-alpha terms.

The system stores this information in a searchable database so documents can be easily sorted by their quality characteristics for computer-aided error resolution purposes. This information is viewable in the table format below:

Document Quality Check*

| Checked | Quality Rating | Exceptions | Trash | Path\File Name |
|---|---|---|---|---|
| [x] | [91] | [88] | [12] | c:det\data\txt_01.txt |
| [x] | [91] | [53] | [47] | c:det\data\txt_02.txt |
| [x] | [84] | [56] | [44] | c:det\data\txt_03.txt |
| [x] | [88] | [73] | [27] | c:det\data\txt_04.txt |
| [x] | [86] | [49] | [51] | c:det\data\txt_05.txt |

* values provided for the purpose of illustration

This capability is useful for screening batches of OCR'd text files according to quality and error characteristics in preparation for computer-aided error resolution. Activating system processes according to these variable values is a means for maximizing efficiency in use of system resources most efficiently. Selecting higher values instructs the system to be more stringent in screening/processing documents. Selecting lower values instructs the system to be lenient in screening/processing documents.

Document Quality Ratings as a factor in Error Resolution

A high quality rating means the document contains relatively few exceptions. By the same token, a document with a high quality rating has a more complete set of valid terms and will have relatively smaller sets of ambiguous solutions, unresolvable exceptions, and trash. The system's error correction processes will therefore tend to generate more solutions with high confidence values and fewer solutions with lower confidence values. Consequently, “corrections” made in documents with high quality ratings will tend to be “correct” more often.

A low quality rating means the document contains a relatively high number of exceptions. By the same token, a document with a low quality rating has a less complete set of valid terms and will have relatively larger sets of ambiguous solutions and unresolvable exceptions. The system's error correction processes will therefore tend to generate more low quality solutions and fewer solutions with high confidence values. The net result is a lower level of “correct” error resolution.

Because of the significance of a document's quality rating, the system has been designed to weight the solutions it generates to reflect the quality characteristics of each working document. Confidence values of solutions are accepted at par in documents with high quality ratings. Confidence values of solutions are adjusted downward in documents with low quality ratings.

Error Reduction Factors

The system calculates an error reduction factor for each processed document. For purposes of this discussion, the ERF identifies the percent of “correct corrections” that will be implemented in the document through the error-correction process. For example, a ERF of “25%” suggests that 25% of the errors in the working document will be resolved correctly. The ERF is generated using a formula that reflects the document's solution characteristics weighted in terms of its quality rating. While the ERF does not represent a verified result, the formula has been tested and confirmed in statistically valid sampling.

Calculating the Error Reduction Factor

(Document Quality Rating Adjustment)×

((number of Solutions above 90% Confidence Value×Variable 1)

+(number of Solutions above 80% Confidence Value×Variable 2)

+(number of Solutions above 70% Confidence Value×Variable 3)

+(number of Solutions above 60% Confidence Value×Variable 4)

+(number of Solutions above 50% Confidence Value×Variable 5)

+(number of Solutions below 50% Confidence Value×Variable 6)=Error Reduction Factor

Exceptions Lists

The user can generate and view lists of exceptions prior to launching the error correction process as a means for ascertaining the quality of the text and the characteristics of the errors. The system accomplishes this task by indexing the document(s) that have been loaded for processing, matching their terms against the terms in the user-selected dictionaries, and removing the matching terms. The non-matching terms constitute the “exceptions” list.

The exceptions list contains terms that have known errors such as “Coll!ns”, “h˜ll”, “Co11ins”, “BillSmith”, “cons truction”, and “recieive”. The exceptions list also contains all-alpha terms that are not in the user-selected dictionaries such as, for the sake of illustration, “gassle”, “Jarnes”, and “Mutterland”.

Exceptions lists are used in three system functions:

1. As the look-up table called by the system when instructed to mark “invalid” terms.

2. As reference source for generating “user-generated” dictionaries (See Below)

3. As the reference source for generating “swapout” files (See Below under Error Correction Processes)

Reference Dictionaries

The system's ability to correct text errors depends in part on how well the lexicon in user-selected reference dictionaries match the lexicons of the user's working documents.

High correlation values indicate that a large percentage of terms in the working documents are valid and that number of text errors is relatively small. Low correlation values indicate that the working documents contains a larger number of terms that are not in the user-selected reference dictionaries. This increases the likelihood that the working documents have relatively larger sets of unvalidated terms and invalid terms.

The system's error correction performance can be improved by selecting reference dictionaries that are more complete relative to the lexicon of the working documents. Users can do this by selecting/unselecting reference dictionaries from:

1) System Resident Reference Dictionaries

2) User-generated Reference Dictionaries containing non-validated terms resident in the user's working documents

3) External Reference Dictionaries loaded into the system by the user

1. System Resident Dictionaries

The system contains four resident reference dictionaries which users may select or un-select:

1) commonly used words

2) first names

3) last names

4) spell-checking

2. User-generated Dictionaries

Because working documents contain terms that are not in the system's resident dictionaries (such as technical terms, uncommon proper names, business names, foreign words, and slang words) the system allows the user to locate these terms and to build “user-generated” dictionaries. Users can build “user-generated” dictionaries by selecting and saving terms out of the working documents' all-alpha exceptions list.

User-generated dictionaries are particular to the working documents from which their terms are taken. The “intelligence” they contain enhances system performance in two ways:

1) it removes non-validated “correct” terms from the exceptions lists and allows the system to generate more accurate statistical profiles of the set of working documents.

2) it allows the system to develop solutions when errors occur in these terms.

3. External Reference Dictionaries

External reference dictionaries include technical lexicons and gazetteers, user-generated keyword lists, and indexes of terms created out of free-text documents.

Loading External Reference Documents

System-provided utilities allow users to convert standard ASCII text and database files into the format of the system's reference databases. Users can use this utility to convert lists of terms, free texts, and standard computer databases into system-accessible reference databases.

Solutions and Corrections

For the purposes of this discussion, a distinction is made between a solution and a correction. Here a “solution” is a valid term that has been located in one of the system's reference dictionaries by the system's error correction algorithms. A “correction” is a solution that has been implemented.

Possible Solutions

It is assumed in this process that exceptions residing in working documents were valid terms in their original state. A possible solution is 1) a valid term in one of the system's reference dictionaries, that 2) has been identified by the rules-based process of the system's error correction algorithms as a potentially correct form of the invalid term. An exception may have one possible solution, more than one “possible” solution, or many “possible” solutions.

For example, “Coll!ns” is an invalid term because it contains a non-alpha character. In this case, the system's single invalid character correction algorithm replaces “!” with “a”, “b”, “c” and so forth through “z”. This substitution process creates 26 alpha terms. The system then checks each of these new alpha terms against its reference dictionaries. Of the 26, only “Collins” is in the system's reference dictionaries. The system therefore identifies “Collins” as a “possible” solution. “H˜ll” is also an invalid term. In this case, the invalid term is a tilde. However, unlike “Coll!ns” which has only one “possible” solution, the system locates four valid terms that might be the original form of “h˜ll”. They are “hall”, “hell”, “hill”, and “hull”. “Am@˜!˜tic” is another invalid term. In this case the term has four invalid characters. The system's multiple invalid character algorithm locates five “possible” solutions: “amaurotic”, “ameristic”, “ammonitic”, “amoristic”, and “ampelitic”. Terms like “˜˜˜˜˜˜˜” can be counted as having either a large set of possible solutions (i.e., the set of all valid terms containing six characters) or no discernable solutions. For the purposes of this discussion, the distinction is irrelevant.

Confidence Values

The system ranks possible solutions based on their characteristics. This ranking is called the solution's confidence value. Confidence values are not statistical probabilities that possible solutions are correct. Rather, they reflect the tendency of solutions with certain characteristics to be correct more or less often than solutions with other characteristics. Accordingly, in “n” instances of each possible solution, a solution with a higher confidence value ranking is likely to be correct more often than a solution with a lower confidence value ranking. For example, “Coll!ns” has a higher confidence value ranking that “h˜ll” because “Collins” is the only valid term that is created by substituting valid characters for the term's invalid character. If “Collins also appears in the working document, the system will assigns it a confidence value of 98%. In the case of “h˜ll” four possible solutions exist: “hall”, “hell”, “hill”, and “hull”. The chance that one of these four terms is the correct, assuming they all appear in the document with equal frequency, would be no more than 25%. The system might therefore accept “hall” and assign it a 25% confidence value.

Confidence Values: Solution Characteristic Rankings (where “+” indicates that the term appears in the text and “−” indicates that the term does not appear in the text.)

1. 98% Coll!ns: Collins+

If an exception has a single invalid character, and the system identifies one possible solution, and this solution appears in the text.

2. 98% recieved: received+

If an all-alpha exception has an unambiguous spell-check solution that is in the working text.

3. 96% BillSmith: Bill+Smith+

If, reading from left to right, an exception is found to contain two valid terms, and if these terms appear in sequence in the text.

4. 94% cons truction: construction+

If two non-valid all-alpha terms appear in sequence, and if they combine to form a valid term, and this term appears in the text.

5. 94% cons truc tion/construction+

If two three or more non-valid all-alpha terms appear in sequence, and if they combine to form a valid term, and the term appears in the text.

6. 93% C0ll!ns: Collins+

If an exception has two or more invalid characters, and the system locates a single possible solution, and this solution appears in the text.

7. 92% BillSmith: Bill+Smith−

If, reading from left to right, an exception is found to contain two valid terms, and if only one of these terms appear in the text.

8. 92% recieve: receive−

If an all-alpha exception has an unambiguous spell-check solution that is not in the working text

9. 91% Coll!ns: Collins−

If an exception has only one invalid character, and if the system locates only one possible solution, and the solution does not appear in the text.

10. 90% be˜˜ve: belove+/behove−

If there is an exception with two or more invalid characters, and if the system locates two possible solutions, and only one of them appears in the text.

11. 89% cons truction: construction−

If two non-valid all-alpha terms appear in sequence, and if they combine into a valid term, and if the term does not appear in the text.

12. 89% cons tru ction: construction−

If three or more non-valid all-alpha terms appear in sequence, and if they combine to form a valid term, and if the term does not appear in the text.

13. 88% ama˜e: amaze+/amate−

If an exception has only one invalid character, and if the system locates two possible solutions, the system selects the solutions that appears more frequently.

14. 87% BillSmith: Bill−Smith−

If, reading from left to right, an exception is found to contain two valid terms, but neither of these terms appears in the text.

15. 86% bri˜k: brick+/brink−/brisk−

If there is an exception with only one invalid character, and if the system locates three possible solutions, and if only one appears in the text, the system selects that term.

16. 85% h˜ll: hall+/hell−/hill−/hull−

If there is an exception with only one invalid character, and if the system locates four possible solutions, and if only one appears in the text, the system selects that term.

17. 83% h˜ll: hall+/hell+/hill−/hull−

If there is an exception with only one invalid character, and if the system locates four possible solutions, and two of these solutions appear in the text, the system selects the term which appears more frequently.

18. 82% be˜˜ve: belove+/behove+

If there is an exception with two or more invalid characters, and if system locates two possible solutions, and if both solutions appears in the text, the system selects the term which appears more frequently.

19. 81% C0ll!ns: Collins−

If a term in the text has two or more invalid characters, and if the system locates only one possible solution, but this solution does not appear in the text.

20. 80% bri˜k: brick+/brink+/brisk−

If there is an exception with only one invalid character and if the system locates three possible solutions, and if two appear in the text, the system selects the one that appears most frequently.

21. 70% h˜ll: hall+/hell+/hill+/hull−

If there is an exception with only one invalid character, and if the system locates four possible solutions, and three of these solutions appear in the text, the system selects the term which appears most frequently.

22. 68% br˜˜tle: brattle+/bristle−/brittle−

If there is an exception with two or more invalid terms, and if the system locates three possible solutions, and if one of these possible solutions appears in the text, the system selects that term.

23. 65% gat: gal+, get−, got−, gut−

If there is an all-alpha exception, and if the spell-checker finds more than one but less than five possible solutions, and if only one appears in the text, the system selects that term.

24. 60% gat: gal+, get+, got−, gut−

If there is an all-alpha exception, and if the spell-checker finds more than one, but less than five possible solutions, and if two appear in the text, the system selects the one that appears most frequently.

25. 55% br˜˜tle: brattle+/bristle+/brittle−

If there is an exception with two or more invalid terms, and if the system locates three possible solutions, and if two of these possible solutions appears in the text, the system selects the term which appears more frequently.

26. 50 % be˜˜ve: belove−/behove−

If there is an exception with two or more invalid terms, and if the system locates two possible solutions, and if neither solution appears in the text, the system selects one.

27. 35% gat: gal+, get+, got+, gut−

If there is an all-alpha exception, and if the spell-checker finds more than one but less than five possible solutions, and all three appear in the text, the system selects the one that occurs most frequently.

28. 30% bri˜k: brick+/brink+/brisk+

If there is an exception with only one invalid character, and if the system locates three possible solutions, and if all appear in the text with equal frequency, the system selects one.

29. 30% br˜˜tle: brattle+/bristle+/brittle+

If there is an exception with two or more possible solutions, and if the system locates three possible solutions, and if all of these appear in the text, the system selects one.

30. 28% gat: gal+, get+, got+, gut+

If there is an all-alpha exception, and if the spell-checker finds more than one but less than five possible solutions, and if four appear in the text, the system selects one.

31. 27% br˜˜tle: brattle−/bristle−/brittle−

If there is an exception with two or more invalid characters, and if the system locates three possible solutions, and if none appear in the text, the system selects one.

32. 25% h˜ll: hall+/hell+/hill+/hull+

If there is an exception with one invalid character, and if the system locates four possible solutions, and if all four appear in the text with same frequency, the system chooses one.

33. 23% gat: gal−, get−, got−, gut−

If there is an all-alpha exception, and the spell-checker finds more than one but less that five possible solutions, and if none appear in the text, the system selects one.

34. 22% h˜ll: hall−/hell−/hill−/hull−

If there is an exception with one invalid character, and if the system locates four possible solutions, and if none of these solutions appear in the text, the system selects one.

35. 0% th˜˜˜: their/there/these/those/three/throw

If the system locates more than four possible solutions for an exception, the system considers the error unresolvable.

36. 0% ˜˜˜@

If the system locates no possible solutions for an exception, the system considers the error unresolvable.

Adjusting Confidence Values for Documents with Declining Quality Ratings

Document quality ratings impact solution confidence values. As mentioned earlier, documents with high quality ratings have fewer invalid terms, fewer non-validated terms, and more complete sets of valid terms. For documents with these characteristics, the confidence values of the possible solutions located by the system are accepted at par. By the same token, documents with lower quality ratings have more invalid terms, more non-valid terms, and less complete sets of valid terms.

The system might therefore reduce the confidence value of its solutions as document quality declines to reflect the likelihood that there may be other undefined failures. An example of this would be:

| | | | | | | |
|---|---|---|---|---|---|---|
| Quality | 90-100 | 80-90 | 70-80 | 60-70 | 50-60 | Under 50 |
| Rating | | | | | | |
| Confidence | | | | | | |
| Values | | | | | | |
| 90-98 | 0 | −1 | −2 | −3 | −6 | −12 |
| 80-89 | 0 | −2 | −5 | −8 | −12 | −15 |
| 70-79 | 0 | −3 | −6 | −9 | −13 | −16 |
| 60-69 | 0 | −4 | −7 | −10 | −14 | −17 |
| 50-59 | 0 | −5 | −8 | −11 | −15 | −18 |
| 40-49 | 0 | −6 | −9 | −12 | −16 | −19 |
| 25-39 | 0 | −7 | −10 | −13 | −17 | −20 |
| 0-24 | 0 | −8 | −11 | −14 | −18 | −21 |

At some point, declining document quality ratings and falling confidence values will impact on the computer-aided error correction process sufficiently to make the process unworkable. For purposes of this discussion, this is considered confirmation that the document in question is unsuited for optical character recognition image-to-text conversion.

Document Statistics and Solution Statistics Reports

The system generates document statistics reports and solution statistics reports.

Document statistics reports includes:

Total number of terms in the uncorrected document

Total number of invalid terms in the uncorrected document

Total number of exceptions in the uncorrected document

Total number of “trash” terms in the uncorrected document

Pre-correction document quality

Error Reduction Factor

Post-correction document quality

Document quality improvement

Solution statistics reports include:

Number of exceptions for which solutions were found

Number of invalid terms by error type

Numbers of Solutions ordered by adjusted confidence value

Generation II (G2) Processing Files

Error corrections and other text modifications are made in “generation two” processing files. “G2” processing files are created when original files are loaded into the system. In this way, the system accomplishes its correction processes without altering the underlying source files. Error Correction, Correction Instructions, and Correction Implementation

Solutions become “corrections” when they are implemented into the system's G2 processing files. Once possible solutions have been implemented, the text is considered to be corrected.

Automating correction implementation is a critical component in the computer-aided Error Resolution process. This can be accomplished when the user logs his instructions into the system's Correction Implementation Table.

The system allows the user to specify which exceptions to correct and which exceptions to mark according to their solution confidence values. In this way, the system provides users with the broadest possible range of implementation options. For example, one user might prefer to mark every exceptions in his working file while another user might prefer to implement solutions which have confidence values over 85% while marking the remaining exceptions.

Correction Implementation Table:

| Confidence Value | Replace | Mark | Replace/Mark |
|---|---|---|---|
| +100 | [ ] | [ ] | [ ] |
| +95 | [ ] | [ ] | [ ] |
| +90 | [ ] | [ ] | [ ] |
| +85 | [ ] | [ ] | [ ] |
| +80 | [ ] | [ ] | [ ] |
| +75 | [ ] | [ ] | [ ] |
| +70 | [ ] | [ ] | [ ] |
| +65 | [ ] | [ ] | [ ] |
| +60 | [ ] | [ ] | [ ] |
| +55 | [ ] | [ ] | [ ] |
| +50 | [ ] | [ ] | [ ] |
| +40 | [ ] | [ ] | [ ] |
| +30 | [ ] | [ ] | [ ] |
| +25 | [ ] | [ ] | [ ] |
| +0 | [ ] | [ ] | [ ] |

Once the user has entered his instructions, he can globally implement his specified corrections from a tool-bar command. All corrections are implemented in the system's G2 text files.

Correction Verification in G2 Processing Files

Verification is understood to mean viewing marked corrections in their G2 processing files. The system facilitates correction verification by providing a hot-key search capability that guides the user from one marked correction to the next through the text.

Reference Images

The system allows users to view terms as they appear in the original *.tif image. To access an underlying image, it is necessary for the system to have the character coordinate file generated by the OCR application in the image-to-text conversion process. *.ccf files record the position of each *.txt file character in its original *.tif image. The user can reference questionable terms in their underlying images by double-clicking on questionable terms as they move through their G2 process file data.

Error Correction Processes

The system supports five error correction algorithms:

1) single invalid character resolution

2) merged word resolution

3) fragmented word resolution

4) spell-checking

5) multiple-invalid character resolution

6) swapouts

7) criteriorize image sector analysis

In addition to these algorithms, the systems provides users with a “swapout” search-and-replace utility.

1. Single Invalid Character Repair: SICR

Invalid characters are defined as non-alphabetical characters and capital letters which may be embedded in alpha terms. The term “Coll!ns”, for example, contains an “invalid” punctuation mark. The term “Co1lins” contains an “invalid numeric character. The term “CoIlins” contains an “invalid” capital letter.

The system first compiles terms with a single invalid character into a look up table. Then, beginning with the first term, SICR replaces the invalid character (the! in the Coll!ns example) with valid alpha characters “a” through “z”. After each substitution, SICR searches the user-selected reference dictionary to determine whether the newly—formed alpha term is in the set of valid terms. The first substitution for the invalid term “Coll!ns” creates the alpha term “Collans”. In this example, “Collans” is not in the set of valid terms. On the ninth substitution, however, SICR creates the term “Collins” which is in the set of valid terms. Proceeding on through “Collzns”, SICR confirms that there is only one possible solution for “Coll!ns”. Since “Coll!ns” has only one possible solution, the solutions is unambiguous.

The system assigns a confidence value to the solution as specified by the solution's characteristics. It also registers information about the solution in the system's solutions statistics report.

“H˜ll” also contains a single invalid character and in this respect it is like “Coll!ns”. However, SICR locates four possible solutions for “h˜ll”: “hall”, “hell”, “hill”, and “hull”. Because there is more than one possible solution for this exception, the solution is ambiguous. Because “h˜” has different solution characteristics, it has a different solution confidence value from “Coll!ns”.

2. Merged Word Repair: MWR

After identifying and eliminating all valid terms, all terms with invalid characters, and all fragmented word errors, the system reads the remaining all-alpha terms left to right to determine if they are comprised of two or more valid terms. For example, “processingcost” is comprised of “processing” and “cost” and “thesystemincludes” is comprised of “the”, “system”, and “includes”.

The system assigns a confidence value to the solution as specified by the solution's characteristics. It also registers information about the solution in the system's solutions statistics report.

Solutions identified may be unambiguous or ambiguous. Unambiguous solutions occur in instances where the system identifies only one valid term as a replacement for an exception. Ambiguous solutions occur in instances where the system identifies more than one term as a replacement for an exception.

3. Fragmented Word Repair: FWR

To identify these errors, the system eliminates all valid terms and all terms with invalid characters. Among the remaining terms, a fragmentation error may exist if two or more invalid terms are found in sequence. “Cons truction” and “con struc tion” are examples of this. In the meantime, the system removes the spaces from between the invalid all-alpha terms and compares the resulting all-alpha term to the user-selected reference dictionaries to determine if it is a member of that set.

The system assigns a confidence value to the solution as specified by the solution's characteristics. It also registers information about the solution in the system's solutions statistics report.

Solutions identified may be unambiguous or ambiguous. Unambiguous solutions occur in instances where the system identifies only one valid term as a replacement for an exception. Ambiguous solutions occur in instances where the system identifies more than one term as a replacement for an exception.

4. Multiple Invalid Character Repair: MICR

HyperLogic is an analytical method with applications that include, for example, resolving errors introduced into texts during optical character recognition. In this application, the HyperLogic method resolves compound and complex character recognition failures as defined below. For purposes of this discussion, a character recognition failure occurs when a character set in a text 1) contains one or more invalid characters (where invalid characters are defined as non-alpha characters) and/or 2) is not a member of a given set of “valid” terms defined here as membership in a user-specified reference database or “lexicon”. A valid term in this discussion is considered to be a “word”.

HyperLogic's processes analyze words in user-specified lexicons to determine which, if any, have characteristics that correspond to the characteristics of the non-word terms in a text. For each non-word term, HyperLogic lists the set of words that have qualifying corresponding component characteristics. A HyperLogic output set may contain no members, one member, or more than one member. For purposes of this discussion, the words in these output sets are considered to be “possible solutions” where a “possible solution” is a term that is 1) a member of a specified reference lexicon and 2) exhibits qualifying corresponding component characteristics of the non-word term.

The HyperLogic method can be used in conjunction with other filtering processes to rank the words in an output set according to the likelihood of their being “correct” where “correct” is understood to mean the true original form of the non-word term. When combined with these attendant processes, the HyperLogic method can be used to enhance the quality of ocr'd documents as a post-OCR error reduction tool.

The logic which guides the Hyperlogic method in its text error resolution applications embodies the following definitions and premises:

1) a “term” is a discreet set of characters.

2) a “word” is a discreet set of characters that resides in one or more specified reference databases.

3) terms that are words and terms that are non-words have these characterizations based on their membership or non-membership in user-specified reference databases.

4) words in the user's specified reference database(s) constitute the system's active “lexicon”

5) there are any number of lexicons, and they are all practically equivalent in respect to HyperLogic's error resolution processes.

6) with the exception noted below, words in an active lexicon can be distinguished from other words in the same lexicon, and from terms that are not members of the active lexicon, by their character sets, the order of their characters, and their length.

6) in active lexicons there are finite numbers of words, most of which have less than 50 characters.

For purposes of this discussion, lexicons are applied in “language”. There are, therefore, languages of “medicine” in which medical lexicons are applied and languages of “law” in which legal lexicons are applied.

Although Hyperlogic uses specified lexicons in its text error resolution processes, it is not specifically concerned with language. Furthermore, it is understood that lexicons frequently contain words that have more than one “meaning” or use in language. As a tool for resolving text errors, and in its other applications, the HyperLogic method is not concerned with “meaning” and does not distinguish between words on the basis of meaning or use. Likewise, while existing terms may take on new meanings and uses, and while new terms may be formed, take on meaning, and gain use, this dynamic aspect of language is irrelevant to the performance of the HyperLogic method so long as the “lexicon” available to the system is appropriate to the current requirement.

The HyperLogic method is focused on two categories of character recognition failure:

1) multiple invalid character errors (e.g., apothec˜˜y, ap˜th˜˜ary)

2) character substitution errors (e.g., apomecary, apolhecary, apolllecary)

For purposes of this discussion, a multiple invalid character error is a compound character recognition error because it involves more than one character recognition failure. A character substitution error is a complex character recognition failure because several levels of processing are required for resolution.

A compound character recognition error occurs when more than one alpha character in a word is incorrectly identified as an invalid character, which for purpose of this discussion are represented as ˜'s, during optical character recognition conversion from image to text. A complex character recognition error occurs when one alpha character is incorrectly recognized as different alpha character during optical character recognition conversion from image to text.

The HyperLogic method applies “first level” processing to find solutions for words that contain compound character recognition errors and “second level” processing to find solutions for words that contain complex character recognition errors. These processes are described below. HyperLogic data structures are described in connection with the HyperLogic search algorithm. For purposes of this discussion, “index” refers to a list of items and “row number” and “occurrence number” refer to the positions of items in an index.

First Level Processing

HyperLogic begins first level processing by creating three “primary” indexes. Each primary index contains information about a particular component for the words in the user's specified lexicons:

1) the character component index contains data structures with the characters that constitute each word in the lexicon (e.g., the set of characters that constitute apothecary contains a, c, e, h, o, p, r, t, and y).

2) The character relationship index contains data structures with the character relationships and the order of the these character relationships for each word in the lexicon (e.g., the relationships in apothecary are a-p, p-o, o-t, t-h, h-e, e-c, c-a, a-r, and r-y in that order)

3) the word length index contains data structures with the number of characters each word in the lexicon (e.g., “apothecary” has (9) characters).

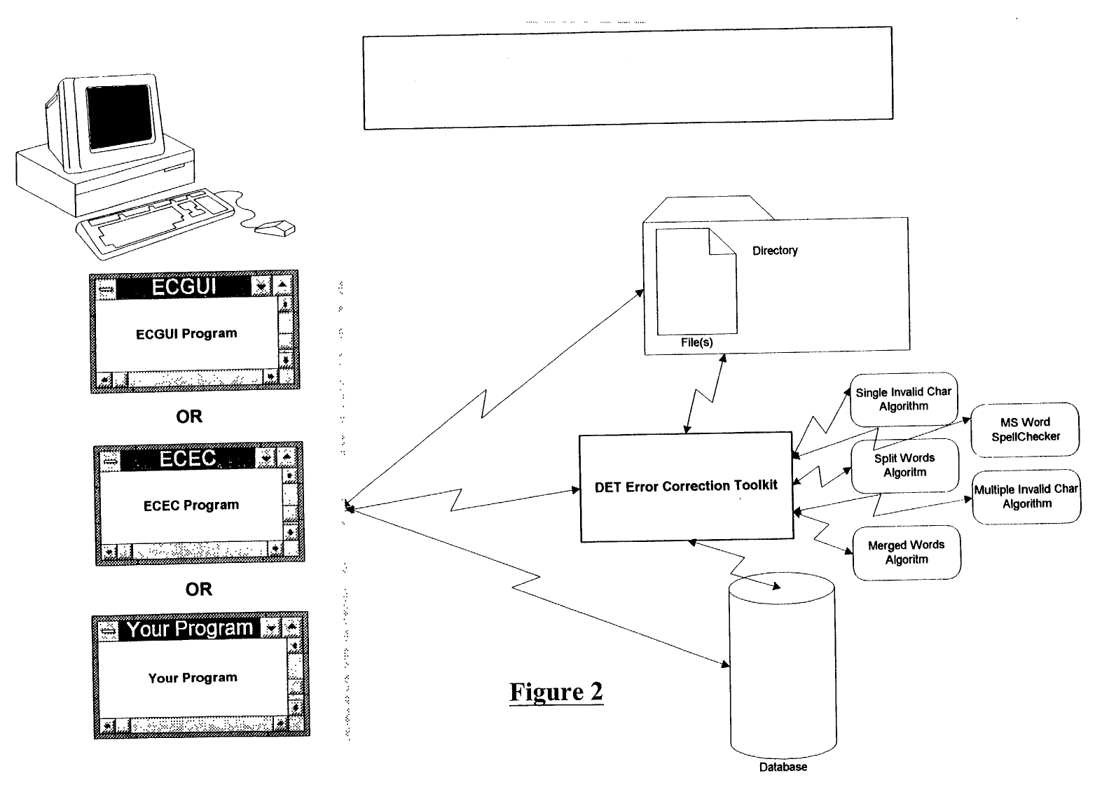

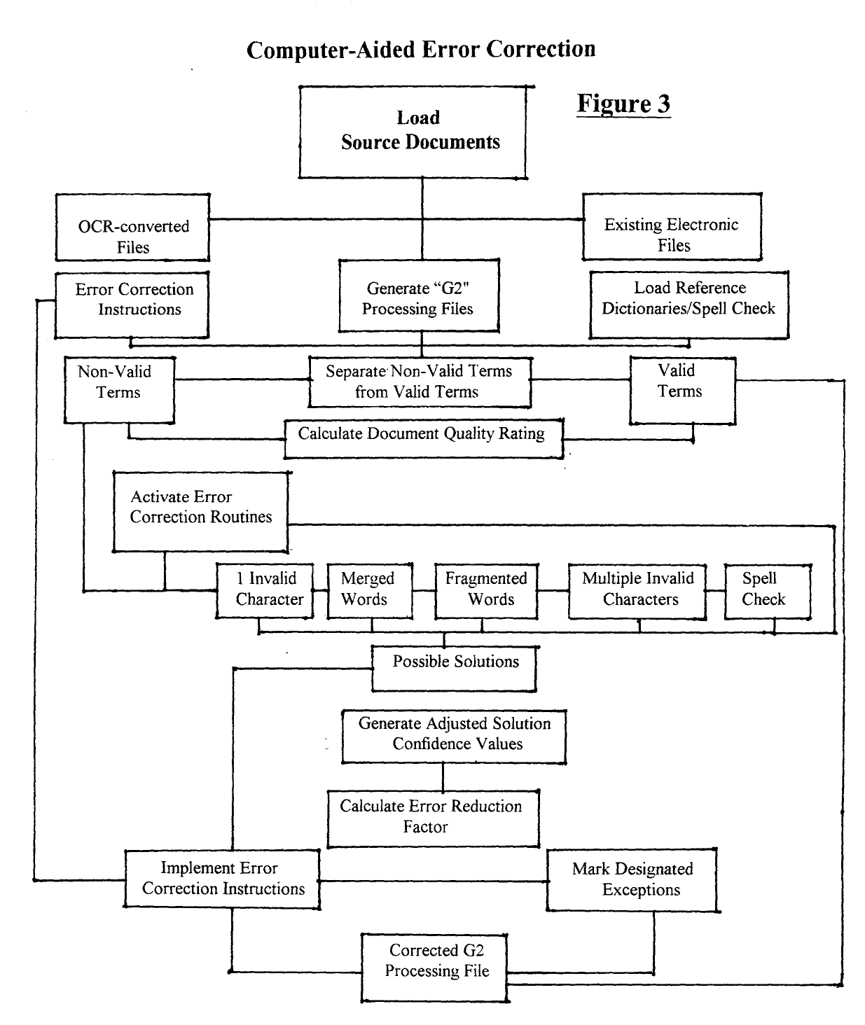

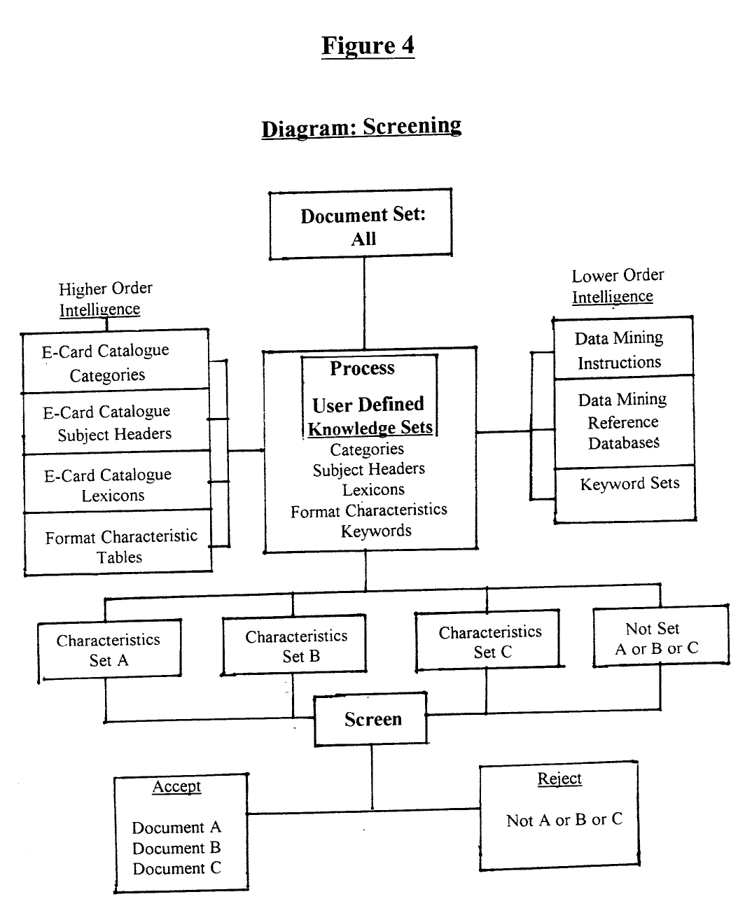

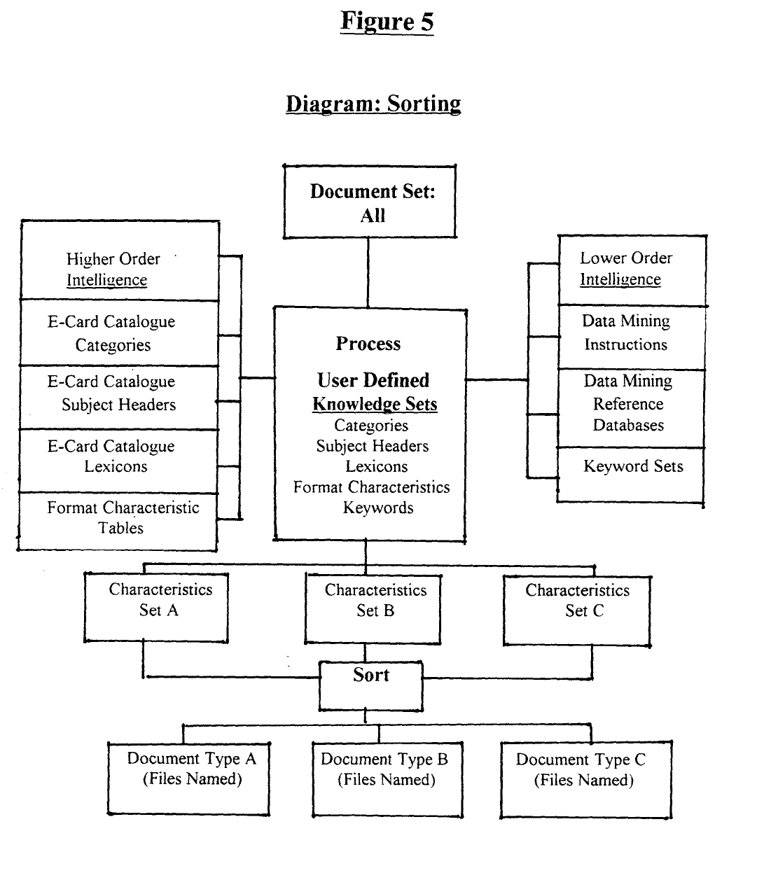

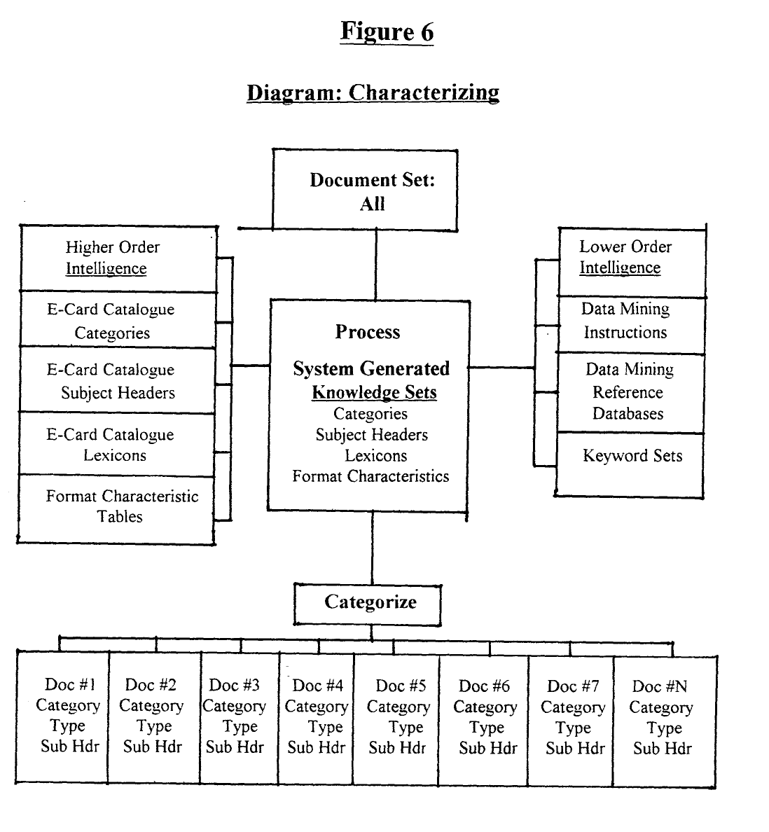

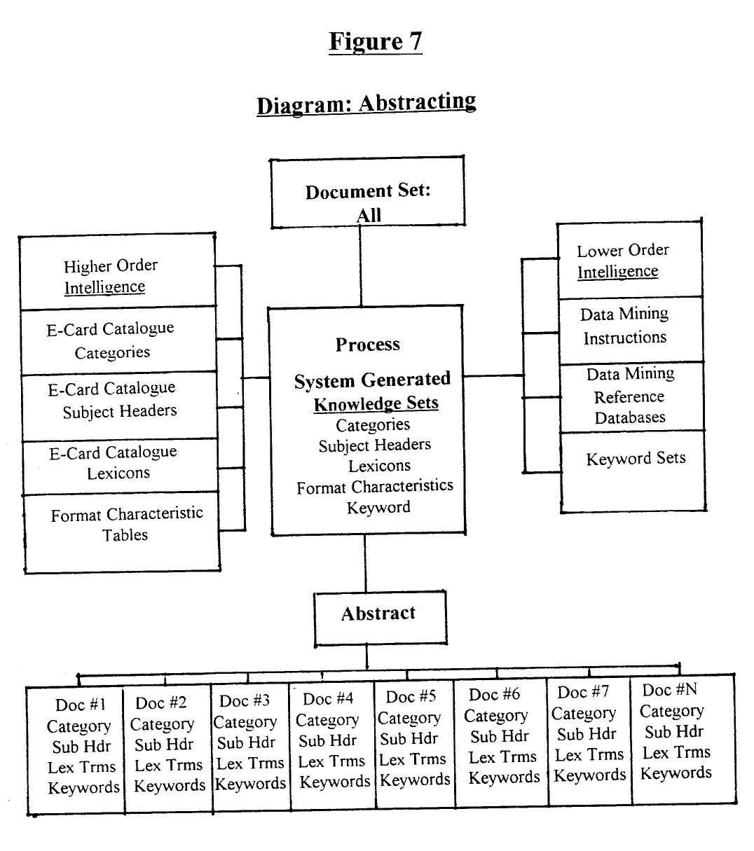

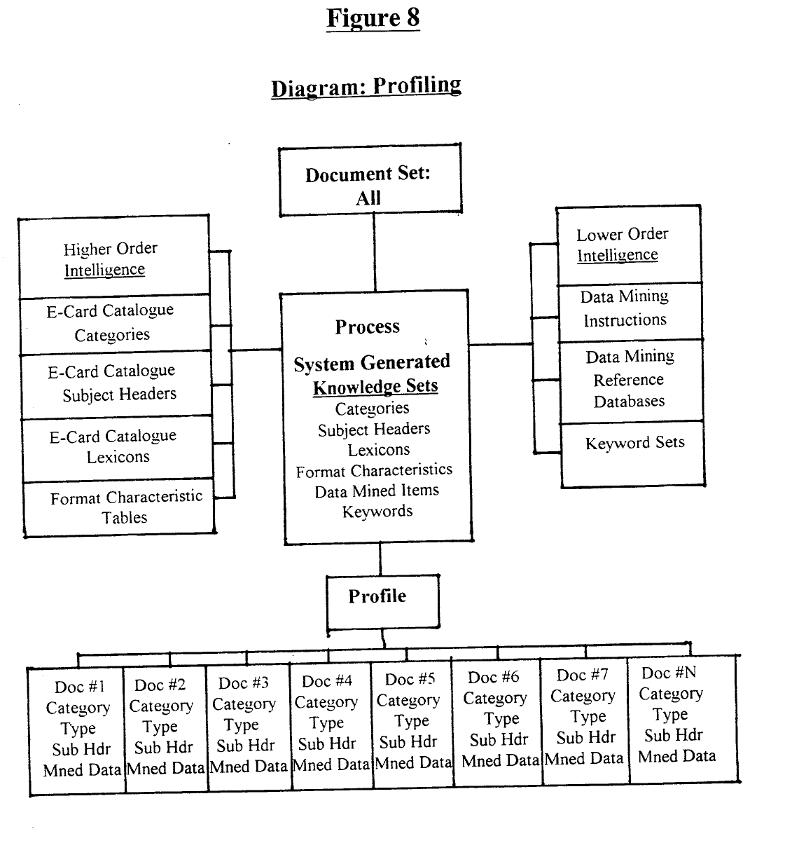

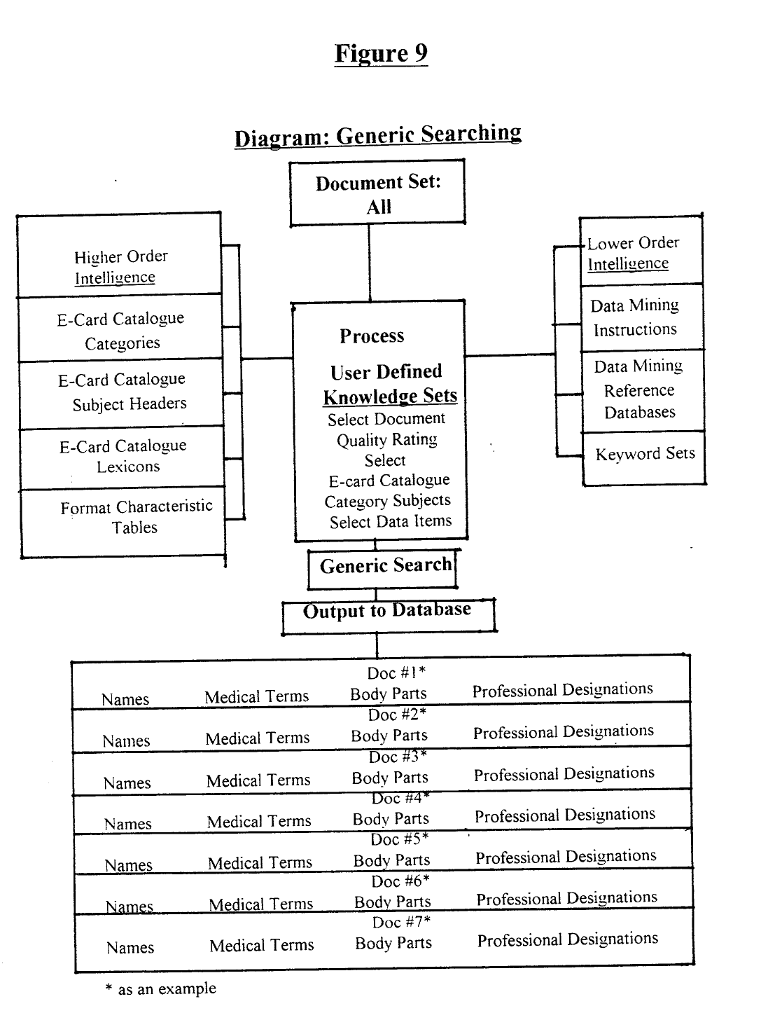

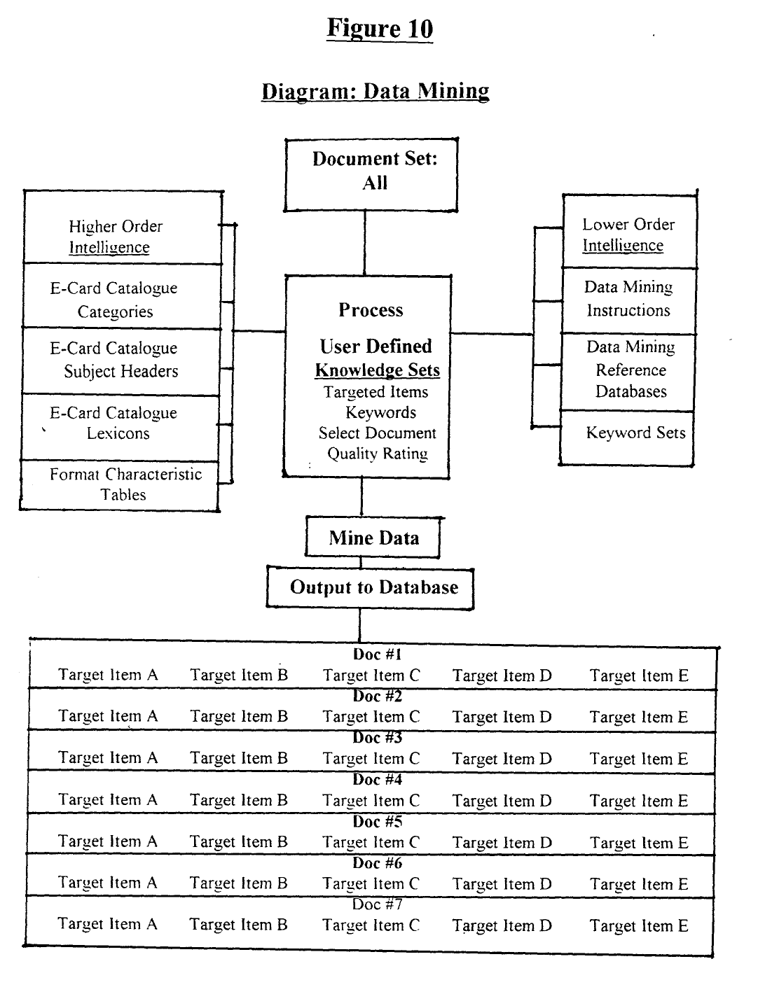

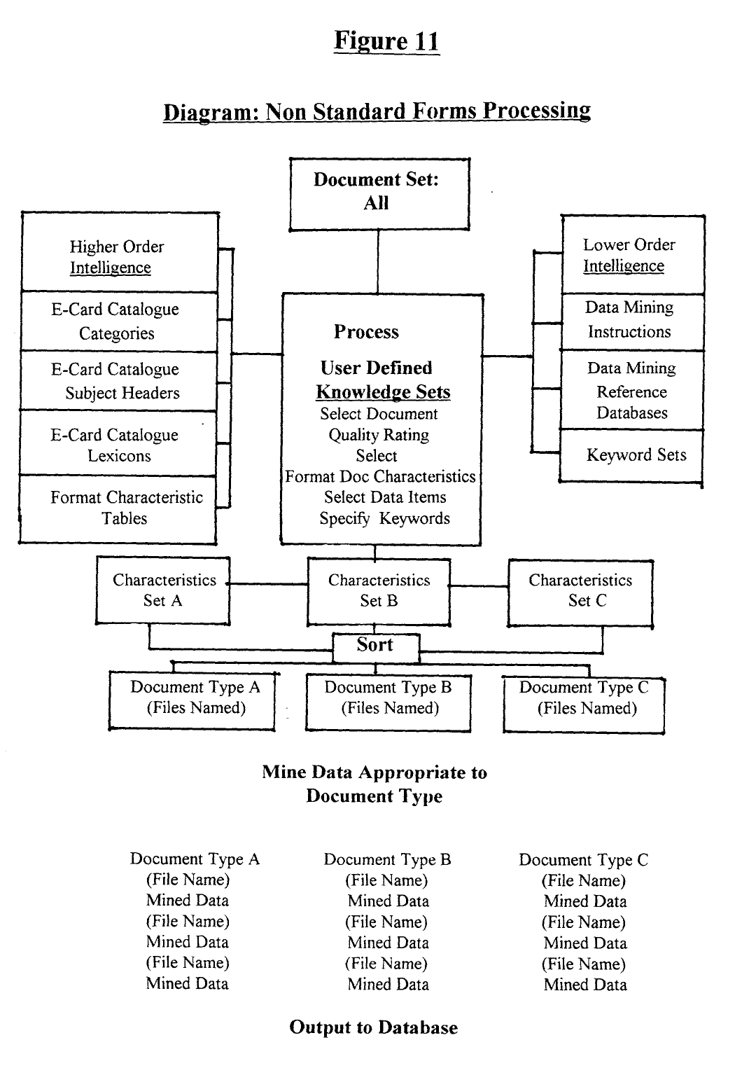

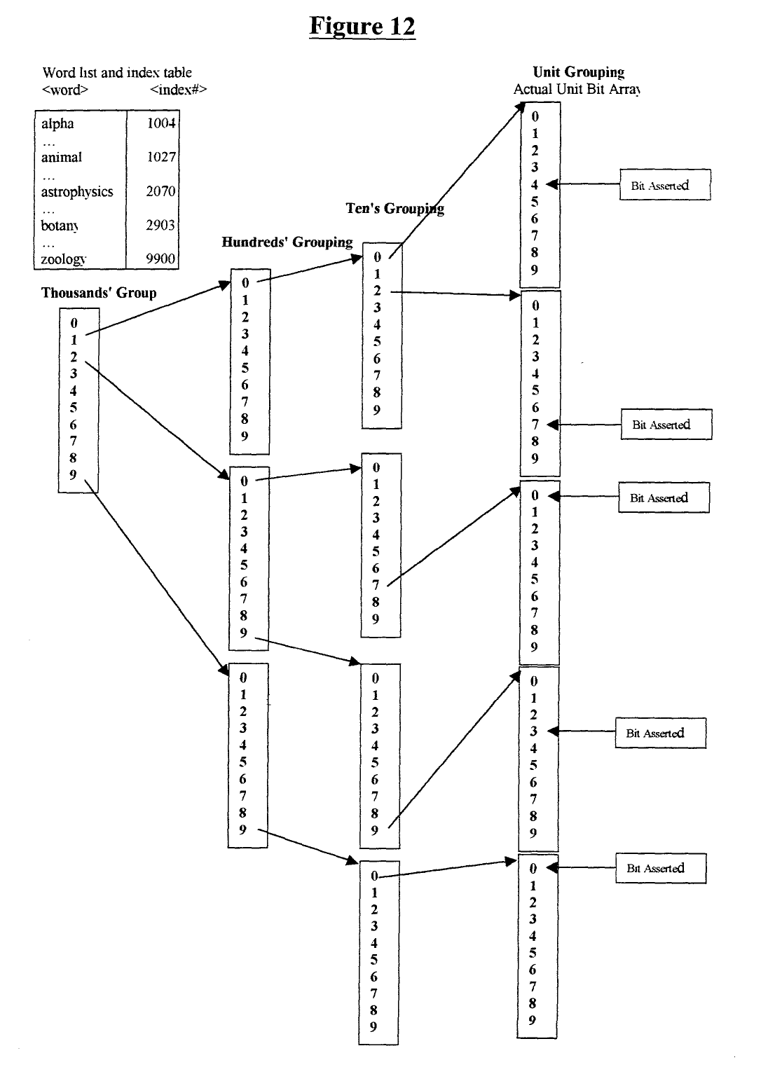

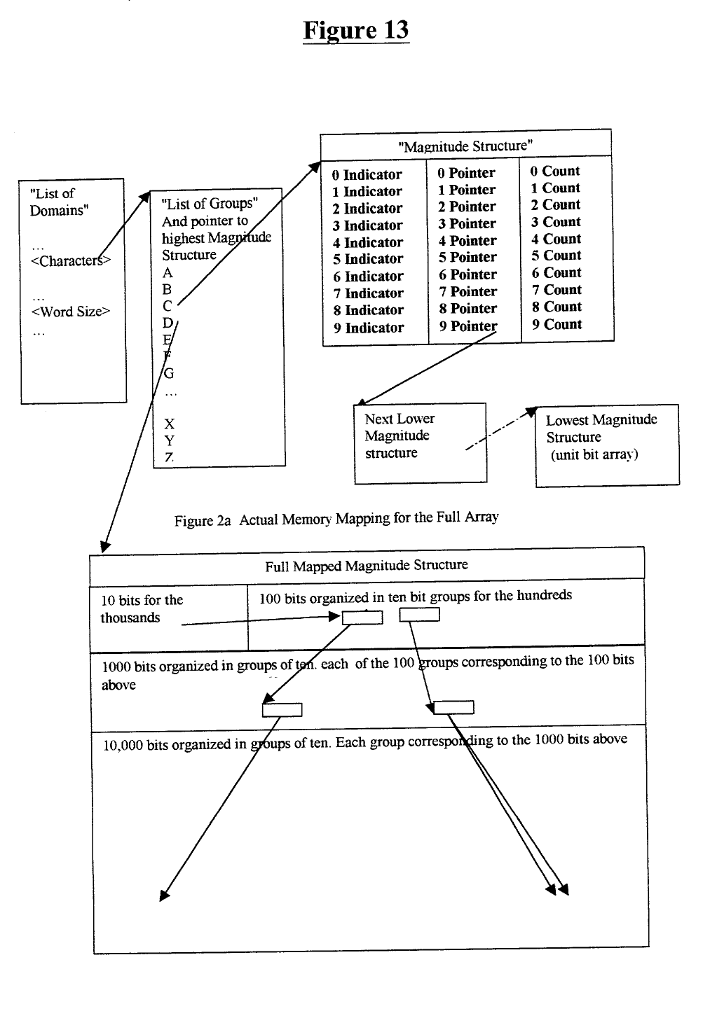

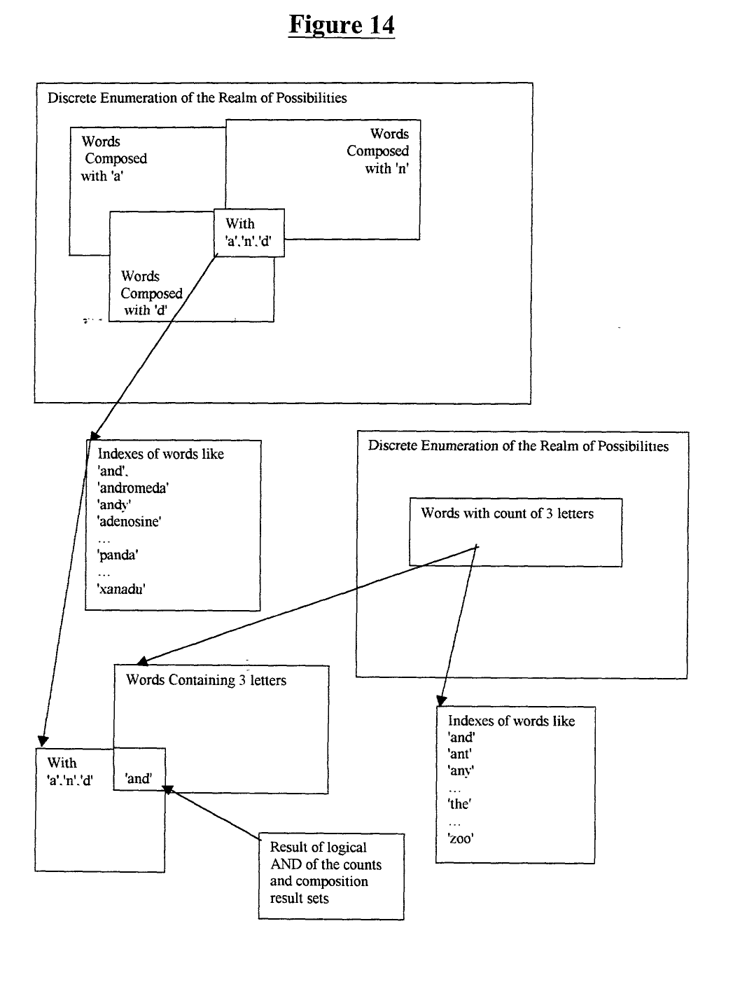

These indexes associate component characteristics of each word with a “row number” or “occurrence number” which identify that word to the system. (See FIG. 2, 2a, and 3). For purposes of this discussion, these three primary indexes represent the “discrete enumeration of the realm of possibilities”. Words represented in these indexes need not be unique, but it simplifies the process if words are unique. Non-unique word entries will result in non-unique search results.

As is the case for words in user-specified lexicons, compound character recognition errors (for example, ap˜the˜ary) have 1) character relationships which appear in specific orders (i.e., a-p, t-h, h-e, a-r, and r-y), 2) “cluster” relationships which appear in specific orders (i.e., a-p, t-h-e, a-r-y) and 3) a word length (i.e., 9). But because these sets are incomplete relative to words in the user's specified lexicons it is not practical to resolve these errors by simply identifying the occurrence numbers of data structures in the system's primary indexes that have equivalent values.

Instead, HyperLogic resolves compound character recognition errors by creating a derivative index based on data structures in the second primary index (the character relationship index). This derivative index contains only those data structures that have sets of character relationships in the same order of the error and the same cluster sets in the same order as the error. Having in this way distilled the primary lexicon into a set of possible solutions, HyperLogic tests these data structures against the data structures in the third primary index (the word length index). Some qualifying data structures may have the same exact length. Some qualifying data structures may be (1) or (2) characters longer or shorter that the error. The qualifying data structures that are the same exact length are given a higher value than data structures that are (1) character longer or shorter. Data structures that are (1) character longer or shorter are given a higher value that data structures that are (2) characters longer or shorter. Data structures whose length variance is greater that two are discounted as possible solutions. Qualifying data structures that are within (2) characters in length of the error are considered to have the same “approximate” length. In this way, the system's error resolution process uses word length as a “qualifying variable”.

Data structures that have been in this way qualified in terms of character relationships, cluster order, and length are considered to be “possible solutions” if they begin with the same character relationship as the text error. For example, “apothecary”, “flapothecary”, and “trapothecary” all have the same character relationships and cluster order as “ap˜the˜ary”. However, only “apothecary” begins with the same binary character relationship set.

HyperLogic counts the number of data structures that are possible solutions. If there is only one, it presents that word as the “correct” solution. If there is more than one, the solution is considered ambiguous. Ambiguous solutions may be resolved using supplemental filtering techniques such as by analyzing the fequency of binary character combinations in the user's specified lexicon and in the working document(s) as a means for assigning probabilities to the possible solutions.

Second Level Processing

As with first level processing, HyperLogic begins second level processing by creating three “primary” indexes:

1) the character component index.

2) The character relationship index.

3) the word length index.

Second level processing resolves a more complex category error in the sense that character misreads in complex character recognition failures are generically similar to the correct characters that they replace. For example, in the term “wlth” the “l” should actually be a “i”. In the term “durmg” the “m” should actually be “in”. In “surnmer” the “rn” should actually be “m”.

In the case of “wlth” the error was to misread a single character. Consequently, the non-word term “wlth” is the same length as the word in its correct form. In the case of “durmg” the error was to merge two correct characters into a single incorrect character. Consequently, the non-word term “durmg” is one character shorter than the word in its correct for,. In the case of “surnner” the error was to fragment one correct character into two incorrect characters. Consequently, the non-word term “surnmer” is one character longer than the word in its correct form.

The critical problem in respect to identifying solutions for these three catagories of complex character recognition error is to identify which character/characters are incorrect.

HyperLogic solves this problem by applying a technique called “sequential substitution”. Sequential substitution is a three step process. In step one, the system substitutes “˜” for each character in the non-word all-alpha term (e.g., “wlth”). In this way, the system generates a set of non-words, each containing the invalid character “˜’. In the second step, the system substitutes “˜˜” for each character the non-word all-alpha term. In this way, the system generates another set of non-words. In this case, the non-words contain “˜˜”. In the third step, the system substitutes “˜” for each character pair in the non-word all-alpha term. In this way, the system generates another set of non-words.

Although the non-words in this set have one “˜” as did the terms in the first set, these non-word terms have a different length and are therefore different from the non-words in the first set. Given the non-word “wlth”, sequential substitution generates: “˜lth”, “w˜th”, “wl˜h”, “wlt˜”, and “˜˜lth”, “w˜˜th”, and “wl˜˜h”, “wlt˜˜”, and “˜th”, “w˜h”, and “wl˜”. This set of terms contains the error as it actually occurred (i.e., “wlth”=”with”) and ten other character recognition errors that did not occur, but which are generically similar in the sense that the only invalid character is “˜”.

It is necessary to implement these three sets of substitutions because the system cannot know whether the character recognition error was in the “wlth” category, in the “durmg” category, or in the “surnmer” category. Sequential substitution could be expanded to treat character compound complex character recognition failures beyond these categories, but for purposes of this discussion, there would be no material difference in the process.

Sequential substitution, in other words, converts complex character recognition errors into character recognition failures that can be treated with first level processing techniques. In second level processing, however, the system counts solutions as those data structures that have the exact binary character relation sets and the data structures that have the exact length. In this sense, the character relationship component and the word length component are no longer “qualifying variables”. Rather, they are “defining variables”. That is to say, possible solutions in second level processing are limited those data structures that have identical character relationships and identical length in respect to the non-word all-alpha term in question (e.g., wlth).

Theoretically, the set of possible solutions generated in second level processing can be large. However, because the set of non-words that fall into this error category is relatively small to begin with, and because there are not many valid words that have exactly the same character relationships and exactly the same length as the set of non-words generated in the sequential substitution process, the number of solutions generated in second level processing is actually small. In the instances where this is not the case, complex errors will not be resolved.

Magnitude Indexing

The indexing method which supports these HyperLogic analyses represents an important advance over existing methodologies. The improvement derives from a bit map-indexing scheme called magnitude indexing. The advantage of magnitude indexing over other methodologies derives from its ability to substantially reduce the time required to perform the component analyses required to resolved compound and complex character recognition failures as described above.

Magnitude indexing is, in a sense, a digital configuration of a Venn diagram, as developed by the mathematician Venn. Venn's diagrams depicted a vague and abstract universe. In a corresponding way, magnitude indexing operates in a universe containing abstract entities comprised of index values.

Magnitude indexing makes component analysis feasible because it substantially reduces processing time. It accomplishes by the method in which it works with bit arrays. Bit arrays, in this context, represent the fundamental values in the “index numbers” of the terms being indexed. Index numbers might relate to the index of an array of terms or the index number associated with a term in a database table. These numbers are whole numbers starting with and greater than 1. These numbers are used to identify the results of the search.

Bit maps in this process do not store the terms themselves. Rather they store information about the terms. Two qualities are stored for what will be referred to as level 1 processing. These qualities are the constituent characters of the term, and the term's length.

For every unique quality there is an associated grouping of unique values of quantities or range of values for that quality. For example, one quality used for the error correction is the set of characters present. The other for level 1 is the count of the characters. A “term” index is used to represent its presence in as a member of a set of valid terms.

What is easily done visually requires one by one examination in a digital approach. Every point must be examined to check for presence. This is time consuming and requires the same amount of time whether one value is found or every value is found.

The magnitude indexing scheme works in conjunction with the bit map approach. It is actually a “cascading” of bit maps structured to represent the descending magnitude values of an index.

This scheme makes it possible to avoid looking at blank or inconsequential areas of the data structure and to simply look in areas where previous data has been implied to the structure. For example, as a data value is stored in a structure, it is examined. In the example of a number, its most significant digit is placed in the most significant data structure. The next digit is placed in a it s corresponding data array indicated by the previous digit and so on until the final digit is actually set in the structures bit map.

When a search or logical operation is performed the most significant digits are united or merged. If there are any matches, the corresponding lesser significant maps are merged until the final digit or radix level is checked in this fashion. This significantly reduces the time spent looking for relevant items in the bit map approach by limiting the activity to only relevant items.

The system assigns a confidence value to the solution as specified by the solution characteristics as indicated above. It also registers information about the solution in the system's solutions statistics report.

Solutions identified may be unambiguous or ambiguous. Unambiguous solutions occur in instances where the system identifies only one valid term as a replacement for an exception. Ambiguous solutions occur in instances where the system identifies more than one term as a replacement for an exception.

(Also See Diagram Under Magnitude Indexing Arrays)

5. Spell-Check Repair: S-CR

S-CR serves primarily to locate solutions for non-valid alpha terms. This kind of error, an example would be “surnmer”, is commonly considered a spelling error. The system's other error correction algorithms are not designed to solve all-alpha exceptions unless they prove to be fragments in sequence or merged words.

The system assigns a confidence value to the solution as specified by the solution's characteristics. It also registers information about the solution in the system's solutions statistics report.

Solutions identified may be unambiguous or ambiguous. Unambiguous solutions occur in instances where the system identifies only one valid term as a replacement for an exception. Ambiguous solutions occur in instances where the system identifies more than one term as a replacement for an exception.

6. Swapout Error Repair/Swapout Files

Swapout files contain substitution tables for replacing text errors identified by the user. The swapout process allows users to globally repair these specified text errors prior to launching the computer-aided Error Resolution process.

The system allows operators to build and store substitutions tables in which specified terms are replaced with user-formulated “corrections”. For example, “Jarnes”, and “Thornas”, and “surnmer” are commonly occurring OCR misreads. The system would present these exceptions in its all-alpha character exceptions viewer. The operator could them select them into his swapout table and designate a correction for each one in the following way:

“Jarnes”=“James”

“Thornas”=“Thomas”

“surnmer”=“summer”

“durmg”=“during”

Users can create any number of swapout tables. Swapout tables can be of any length. They can be modified, saved, and re-run.

Swapout terms can be added in two ways. First, they can be added by highlighting a term in the text and clicking the right mouse. An edit screen appears with the term as it appears in the text and a blank field where the user can type in the “correct” term. Closing this screen adds the new swapout to the swapout file currently in use. Swapout items can also be added by selecting exceptions in the exceptions viewer as described above.

Swapout Solution Tables

| Number | Items Found | Replace With | # Replaced |
|---|---|---|---|
| 1 | Jarnes | James | 2 |
| 2 | Thornas | Thomas | 3 |
| 3 | surnmer | summer | 1 |
| 4 | durmg | during | 1 |

7. Criteriorized Image Sector Analysis

When the application runs its correction algorithms it determines, in effect, which character sets contain (or may contain) optical character recognition failures. Criteriorized image sector analysis is a post-OCR process in which image sectors which contain these implied character recognition failures are re-examined in the context of the information generated by the system's error resolution algorithms. For example, after the system has determined that “h˜ll” is an invalid term, and after the system's single invalid character repair algorithm has determined that “hall”, “hell”, “hill”, and “hull” are possible solutions, these determinations are information that inform the criteriorized image sector analysis process. CISA uses these criteria to as a basis for re-interpreting data in relevant sectors of an image. In this case, the requirement is to determine whether the image object in question has characteristics more consistent with “a”, or “e”, or “i”, or “u”. If a determination can be made, the process presents that character(s) and in this way contributes to resolving what is considered in this discussion to be an ambiguous solution.

CISA Has Application in Specific Categories Error

CISA is most useful in the instances where the system's error resolution routines have located multiple possible solutions. This would occur in cases of character recognition failure involving a single character (such as “h˜ll”) and in cases involving more than one character (such as (br˜˜tle). CISA is also useful as a tool to resolve character substitution errors. For purposes of this discussion, five categories of character substitution error are recognized:

1. 1-for-1 substitution errors (e.g., “wlth”=“with”)

2. 1-for-2 substitution errors (e.g., “durmg”=“during”)

3. 2-for-1 substitution errors (e.g., “surnmer”=“summer”)

4. −1 substitution errors (e.g., “_pothecary”=“apothecary”)

5. +1 substitution errors (e.g., (“apothecary”=“apothecary”)

It is understood that some of these error may be resolved unambiguously with other error resolution processes. Other categories of error, such as multiple character recognition failures for which no possible solutions are located (for example “˜˜˜˜”), are not specifically suited for resolution using this process.

HyperLogic as a Tool for Full-Text Searching

HyperLogic can be used as a full-text search tool by, in effect, reversing the process described above. In full-text searching, HyperLogic locates terms that are “the same” and “similar” to terms identified by an operator.

The HyperLogic error resolution process searches through specified reference dictionaries for possible solutions for “invalid” terms in a given text or set of texts. HyperLogic full-text searching analyzes “valid” and other terms in a text or set of texts for to locate terms with characteristics of term(s) identified by an operator. For example, if an operator instructs a HyperLogic free-text search to find “apothecary”, the HyperLogic process records the characteristics of “apothecary” which are 1) the letters that constitute it (a, c, e, h, o, p, r, t, y), 2) its character relationships (a-p, p-o, o-t, t-h, h-e, e-c, c-a, a-r, r-y), and 3) the number of letters it contains (9). The HyperLogic process scans the text or set of texts for terms that have these letters, character relationships, and number of letters. The HyperLogic process then scans the text or set of texts for invalid terms that have similar character relationships where “similar” means a set of character relationships that, while not identical, have the same order. Valid terms that have the same character set, set of character relationships, and number of characters are the same word. Invalid terms that have similar character relationships may be the term altered through character recognition failure.

Computer-aided Error Resolution Capabilities in Tool-Kit Formal

Computer-aided Error Resolution processes as described above are suitable for configuration in developer tool-kit format. In this format, users can call pre-packaged computer-aided Error Resolution DLL's as supplemental functions for existing systems, or to accomplish automated solutions for new applications.

Computer-aided Error Resolution as a PC Software Application

Computer-aided Error Resolution is amenable to configuration as a PC software applications to perform post-OCR document quality enhancement and as a functional supplement for other data-processing and text-management operations. In this configuration computer-aided Error Resolution might be a standardized, stand-alone, self-installing PC software application suited for smaller scale requirements in business and non-business venues.

Computer-aided Error Resolution as a Turnkey Solution

Computer-aided Error Resolution is amenable to configuration as a “turnkey” solution to perform post-OCR document quality enhancement and other data-processing and text-management operations. In this configuration computer-aided Error Resolution would be a component in an integrated hardware/software system which might consist of a scanner component, a processor, and various data-processing software applications, including optical character recognition and other document processing software application.

These capabilities could be configured according to a standardized scale of requirements, or on a customized basis.

PC Solution Interface Functions

File

Open File

Open File allows the user to load a file, files, or directory for processing

Select Directory for Processing

Process all the files in a directory/sub-directory

Close File

Close File allows the user to close a file after processing

Close All Files

Close All Files allows the user to close multiple files or a directory after processing

Load User Files

Load User Files allows the user to install his additional reference dictionaries to further instruct the system's error identification capabilities.

Save File

Save File allows the user to save modifications to a single file

Save All Files

Save All Files allows the user to save modifications to all files

Save As

Save As allows the user to save a file under a new name

Exit

Exit allow the user to close the application

Edit

Undo

Undo allows the user to restore the text to its form before the last edit change

Copy

Copy allows the user save a section of text so that it can be duplicated or moved

Cut

Cut allows the user eliminate a section of text from a document

Paste

Paste allows the user insert a selected segment of text into a selected place in a document

Word Wrap

Instructs the system to break lines that extend beyond the right margin so that they can be viewed in the editor

Search

Find

Find allows the user locate a specified term or terms within a document or within a set of documents

Replace

Replace allows the user insert a new term or set of terms in place of an existing term or set of terms

Repeat Last Find

Repeat Last Find allows the user locate the next occurrence of the term or terms in the “Find” field

Search Count

Search Count informs the user how many times the searched item occurs in the text

Next Flag

Next Flag allows the user to hot-key to the next flagged item

View

Show Guide

Shows the list of files loaded for processing

Show Image

Show Image allows the user to view the image of the document in the editor

View Reports

Allows users to call up the solution table and view “Document Statistics”, “Solutions Statistics”, and to view the last set of errors/solutions processed by the system

Processes

Pre-process configuration

Specify solution implementation preferences

Create user-defined reference dictionary

Select reference dictionaries

Select error correction routines

Run Error Correction

Prompts the user to select the error checking algorithms to use in the next process and the reference dictionaries to use in the next process. From this menu users can also:

load extraneous dictionaries

generate the list of invalid terms in the working documents

launch the correction process

Show Invalid Terms

Allows the user to view the exceptions that the system has located in the working files prior to launching the correction process

Generate User Dictionary

Allows the user to select specified all-alpha terms from the exception list and save them in a reference file to supplement the system's resident dictionaries

Separate Capitalized Words

Separate Capitalized Words allows the user to insert a spacer between a lower case letter and an upper case letter (e.g., Adventure Story for AdventureStory)

SwapOuts

Edit Swapout File

Edit Swapout File opens a screen with the following options

Load SwapOut File—allows the user to load an existing swapout file

Save SwapOut File—allows the user to save changes made in an existing or new swapout file

Clear SwapOut file—allows the user to remove a swap out file from the system's swapout routine

Add New Swap Out—allows the user to include another swapout correction to his swapout list

Delete Swap Out—allows the user to remove a swapout solution from his swapout file

Edit Swap Out—allow the user to edit an existing swapout correction

Run Swapouts

Run Swapouts allows the user to launch the swapout correction process

Window

Cascade

Cascade allows the user to display the files he has loaded into the application in cascade format

Tile Horizontally

Tile Horizontally allows the user to display the files he has loaded into the application in horizontal format

Tile Vertically

Tile Vertically allows the user to display the files he has loaded into the application in vertical format

Minimize All

Minimize All allows the user to minimize the files in the edit screen

Arrange All

Arrange All allows the user re-arrange the files in the editor

About

Help File

Help File command allows the user to open the help file

Current Version/Date File

Current Version/Date File contains information about the version of the application that the user is currently using.

Computer-aided Document Profiling

Overview

The computer-aided document profiling processes described below produce elements of knowledge which, when constituted together, form document profiles. For the purpose of this discussion, a document profile contains:

1) a characterization of a document's type

2) a characterization of a document's subject

3) a document's critical content as specified by an operator

For purposes of this discussion, “document type” and “document subject” are considered higher level knowledge. Computer-aided document profiling processes develop these elements of higher level knowledge by analyzing document lexicons and formats in terms of e-card catalogue/knowledgebank intelligence and other knowledge-source databases which are described below. For purposes of this discussion, “critical content” is considered lower level knowledge. Computer-aided document profiling processes develop elements of lower level knowledge using data-mining processes which are described below.

The system's content analysis processes generate elements of higher level knowledge by making, as may be required, lexicon-subject, subject-category, lexicon-category and subject-subject associations. The capacity to form logical relationshipos between these elements of the e-card catalogue/knowledgebank allows the system to perform “intellectual” tasks heretofore dependent upon human intelligence. These tasks include document sorting, screening, categorizing, and abstracting.

Data mining processes which generate elements of lower level knowledge have been created to automate labor-intensive data processing tasks such as generic searching, non-standard forms processing, and other applications which involve extracting textual information.

Intelligence

For the purpose of this discussion, “intelligence” is the functional capability of the lexicons and other reference databases used by computer-aided document profiling processes to accomplish tasks as described below. Computer-aided document profiling processes use intelligence from five sources:

1) “e-card catalogue/knowledgebank lexicons”

2) “format characteristics” reference databases

3) other resident databases such as “first names” and “last names” reference files

4) user-generated lexicons and “keyword” lists

5) instructions contained in the system's data-mining routines

E-card catalogue/Knowledgebank Lexicons

Knowledgebank lexicons are word sets that in some way relate to the name of the lexicon. For example, a lexicon with the name “All Birds” contains a list of all bird names. A lexicon with the name “Accounting Terms” contains the list of all simple and complex terms meaningful in the practice of accounting.

Knowledgebank lexicons are stored and accessed in a hierarchical directory system referred to here as the e-card catalogue. Assigning lexicons names related to their content and storing these named lexicons in a classification system which organizes these lexicons according to categories and sub-categories of knowledge imparts to these lexicons “intelligence” in the sense that they can be used by computer-aided document profiling and other computer processes to develop higher level and lower level knowledge.

Users can configure the system's intelligence to suit their particular requirements by loading knowledgebank lexicons from specified e-card catalogue categories/sub-categories. Computer-aided document profiling processes analyze the content of the user's working documents to determine the content correlation between the terms in the working documents and the lexicons in the e-card catalogue/knowledgebanks.

Format Characteristics Reference Databases

Format characteristics reference databases are called in the computer-aided document profiling process to identify document type.

Correspondences, for example, commonly have a date, an opening salutation, e.g., “Dear”, and a farewell, e.g., “Yours truly”. The format characteristics reference database might specify these items as identifying characteristics of correspondences. The computer-aided document profiling processes calls this reference database and analyzes the content of the document to determine whether it has these, or compatible characteristics of, in this case, correspondences.

Other Resident Databases

Other resident databases are called in the computer-aided document profiling process to locate and extract critical content. The system, for example, supports “first name” and “last name” databases which are called in the process of recognizing and extracting names. The term “Bob” is in the first name reference database. The term “Smith” is in the last name reference database. Computer-aided document profiling processes examine the text for terms like these, which are recognized as names by virtue of their presence in these reference databases. System processes also contain linking instructions to recognize these terms in compounded formats such as “William B. Smith”, “Smith, William B.”, “W. B. Smith”, “W B Smith”, “W. B Smith”, etc. . .

User-generated Lexicons and “Keyword” Lists

Users may create their own lexicons and create their own “keyword” lists to expand system intelligence and refine its profiling capabilities. Users can create new lexicons with the system's VocabularyBuilder utility. (See below.) Users can create keyword lists using the system's keyword list utility, or users can load work lists created in ordinary text editors. (See Below)

Data-mining Routines:

Computer-aided document profiling processes include routines that perform data mining tasks. These routines contain instructions that characterize character sets as names (as described above), dates, telephone numbers, e-mail addresses, and web-sites. Additional data mining routines locate and extract “keywords” as may be identified by the users. (See below)

Applications

Content Analysis

Screening

For the purpose of this discussion, “screening” means:

1. eliminating or otherwise excluding documents that do not have specified characteristics

2. selecting or otherwise including documents that have specified characteristics

For example, a batch of documents containing both legal forms and medical forms might be screened to exclude the “legal forms”.

Sorting

For the purpose of this discussion, “sorting” means separating documents into specified sets or according to specified orders. For example, a batch of documents might be sorted into the set of “legal forms” and the set of “medical forms”.

Categorizing

For the purpose of this discussion, “categorizing” means describing the document in terms of an e-card catalogue category, e.g., “legal” or “medical“, or according to document type, e.g., “correspondence”.

Abstracting

For the purpose of this discussion, “abstracting” means to summarize in some meaningful way a document's content. For example, an “abstract” might contain all pharmacological terms contained in a pharmacology journal article.

Data Mining

Generic Searching

For the purpose of this discussion, “generic” searching means finding all members of a specified knowledge set, where the knowledge set is a subject header in the e-card catalogue or the name of a knowledgebank lexicon, e.g., “Cities”, or a data mining target, e.g., “Names”. In a standard search an operator asks the system to locate all instances of a specified character set. For example, if an operator searched for “Bill Smith” the system would locate all instances of “Bill Smith”. In a generic search, an operator might, for example, designate the data mining target “Names”. The system might then locate “Bill Smith”, “William Smith”, “William B. Smith”, W. B. Smith”, “Smith, Bill”, and “Bob Jones”.

Data Mining

For the purpose of this discussion, data mining means locating/extracting specified target free text working documents. For example, “Names”, “Dates”, and “Telephone Numbers” can be specified as target An operator having specified these target items, the system searches the working files for these target items and copies them into an appropriate item field in an output database.

Non-standard Forms Processing

For the purpose of this discussion, non-standard forms processing means locating/extracting target items in business and other documents that do not have a standard format. For example, while a mortgage title is a common legal form, and while all mortgage titles contain certain specified element of information, these elements of information are not found in the same location from one document to the next.

Document Profiling

Document profiles contain higher level knowledge and lower level knowledge. Higher level knowledge is information which the system develops by analyzing a document's format and lexicon as described above Lower level knowledge is located/extracted from a document's text as described above.

Higher Level Knowledge

Document Type:

The system may be programmed to identify types of documents (such as medical forms, legal agreements, financial reports, business records, and correspondence) by comparing their formats and contents with information stored in the system's pre-configured databases. An identification is made when the system determines that the characteristics of a document correspond to the characteristics of an established document type. For example, a medical form, by definition, contains a list of queries, medical terminology, and other distinguishing characteristics, including perhaps a form name or a form number.

The system's document identification capabilities can be expanded by specifying characteristics appropriate for new documents. For example, an “invoice” is a business form which contains a date, a recipient, a request for payment, a balance due and other characterizing items of information.

Document Subject:

Computer-aided document profiling processes characterize document lexicons in terms of lexicons in e-card catalogue knowledgebanks. For purposes of this discussion, a document subject is considered to be the subject name of the lexicon In the e-card catalogue/knowledgebank with the highest content correlation value.

To identify a document's topic the system reads the document into an index of the terms contained in it. It then compares this list of terms to the intelligence provided to the system by the user. This intelligence is comprised of e-card catalogue lexicons that have been selected by the user and loaded into the system as reference databases.

The system lists in descending order knowledgebank lexicons that have content correlation with the word list of the working document. The lexicon with the highest correlation value is considered to be the document's subject. For example, the lexicon of a “will” exhibits a content correlation with several lexicons in the e-card catalogue's “legal” category. However, the highest content correlation is with the lexicon whose subject name is “Will”.

Lower Level Knowledge

Critical Content

Critical content, for the purposes of this discussion, is considered to include: 1 ) the terms in the document that are part of the vocabulary of the document's topic, 2) names, 3) dates, 4) addresses, 5) telephone numbers, 6) e-mail addresses, 7) key words, phrases, and other character sets in reference files loaded by the user. Data mining routines locate/extract these targeted items as described above.

Other System Processes

Master Indexes

The system creates a master index for each document it processes. This master index contains all terms and alpha-numeric character sets found in the text of the document. The system also counts the number of occurrences of each term and presents this number with the term. The master index comprises the vocabulary of the document.

Content Correlation Values

The content correlation value of a working document is a number that reflects the similarity of a working document's lexicon to lexicons in the system's knowledgebanks. The higher the content correlation value between a working document's lexicon and lexicons in the system's knowled˜ebank, the more likely it is to pertain to the subject heading of the knowledgebank lexicon as characterized in the e-card-catalogue. Since individual terms may appear in more than one knowledgebank lexicon, the lexicon of a document will have some degree of content correlation with many knowledgebank lexicons. The content correlation value of a document is based on a calculation that factors in the number of matching terms, the number of times the matching terms occur, the percentage of matching terms in document, the size of the document, and the number of non-matching terms in the document.

Grammatical Sets

A grammatical set may be of sentence or a clause within a sentence. The system detects grammatical sets by locating word sets that begin with tabs followed by capital letters and ending in a “.”, a “?”. or an “!” Or a grammatical set may be one of these characters followed by a space/capital and a capital letter or a carriage return. A grammatical set may also begin with a “,” a “;”, or a “:” and end with “,” a “;”, a “:” or a “.”, a “?”. or an “!”. Grammatical sets are analyzed in the vocabulary building process to locate compound terms.

Output Databases

Documents may be processed in batches of indefinite size. The system compiles the profiles of the individual documents in such a batch into a comprehensive database. Users are thus able to perform searches across the entire batch. For example, an attorney doing discovery could isolate within a massive set of document those items that were correspondence after a specified date involving Sam Somebody and dealing with the topic of bankruptcy.

VocabularyBuilder

VocabularyBuilder is a system utility that allows users to generate new lexicons. Having loaded one or more documents, the user selects the “create vocabulary” command a screen appears which contains an editor with the document. A column appears beside it which contains (3) function boxes. The first function box displays the system's existing Knowledge Categories. The second function box is a data field into which the user enters the name of this new vocabulary. The third function box contains the lexicon of the document in the editor. The user creates the lexicon by highlighting the correct Knowledge Category, then typing the name of the vocabulary in the function box below.

The system give the user the option to de-select parts of speech. De-selected parts of speech are automatically removed from the document's lexicon. Terms are considered to be “value neutral” if they do not contribute identification value to the lexicon. For example, pronouns, prepositions, conjunctions, and articles are in most instances value neutral and can be eliminated from a vocabulary without diminishing its unique identity.

Once the vocabulary generator has indexed the document's individual terms, it analyzes the documents grammatical sets to identify the documents “compound terms”. These are then added to the vocabulary.

VocabularyBuilder defines compound terms as a set of terms that begins within a grammatical set. Compound terms might be the sub-set of terms within a grammatical set preceding a verb or a clause punctuation mark, or following a verb but preceding the closing punctuation.

To Configure System Intelligence

Users can configure system intelligence according to their requirements. Doing so enhances system performance. In the first place, configuring the system's intelligence to reflect the knowledge categories pertinent to the current application reduces the potential for “confusing” the system. The potential for this increases as the system analyzes working document in terms of expanded numbers of inappropriate categories of knowledge. If, for example, a document set pertains to sports, and if a users is not interested in finding sports features, there would be no point in configuring the system's intelligence to include “sports”, Additionally, from a processing standpoint, reducing the number of reference databases reduces the strain on the processor which reduces the time required to complete processing work.

System Intelligence is Configured from the Following Repositories:

1) E-card Catalogue/Knowledgebank Lexicons

The e-card catalogue is an on-line repository of knowledgebank lexicons. Intelligence in this repository is available for downloading through internet access. User locate knowledgebank lexicons by entering keywords into the e-card catalogue's search routine. The e-card catalogue search routine then searches its category names, sub-category names, lexicon subject headers, and the lexicons themselves for matches. The search routine lists the items in which matches are found. If a match occurs in a category name, the user can select all lexicons in that category, or lexicons in the category's sub-categories. Selected knowledgebank lexicons can then be downloaded and loaded into the system to guide the computer-aided document profile processes prior to launching the computer-aided document profiling process.

2) Format Characteristics” Reference Databases

Format characteristics reference files are reference databases that are called by the system in the process of identifying a document type.

3) Other Resident Databases

The system calls other resident databases to perform data mining tasks. These databases are loaded as users select target items to mining in the data mining process. For example, if a user selects “Names” as a data mining target, the system calls its “F Name” and “L Name” databases and the uses the instructions in the data mining “names” routine to locate compounded formats of the terms in these databases.

4) User-generated Lexicons and “Keyword” Lists

User-generated lexicons are lists of terms selected out of the user's working documents. To create a user-generated lexicon the user loads his free text file into VocabularyBuilder and converts the text into a de-duplicated list of the terms it contains. The lexicon is formed by naming this list and saving in the system's knowledgebank catalogue. Lexicons in this repository can be called by activating the “load user dictionary” command in the set-up menu.

Keyword lists can be loaded from the command line. Keyword lists are ascii text files containing lists of words relevant to the interests of the user. Keyword lists can be saved an any user selected directory and re-used. Keyword lists are loaded from the Keyword menu on the system's PC application command line.

5) Instructions Contained in the System's Data-Mining Routines See #3 above

To Add a New Document Type Reference Database

The system makes a “document type” characterization when it finds that a file's data format characteristics correspond with the format characteristics of a specified document type. These characteristics are defined in terms of specified sets of variables which may include format characteristics of the file data and characteristics of the file content. These might include, for example:

[ ] Document contains columned pages

[ ] Pages contain ( ) number of columns

[ ] Document contains a database

[ ] Document contains free text

[ ] Document contains page headers,

[ ] Document contains paragraph headings

[ ] Document contains page footer-one page

[ ] Document contains page footer-all pages

[ ] Document contains enclosed text

[ ] Document contains font consistency

[ ] Document contains font inconsistency

[ ] Document contains footnotes

[ ] Document contains uniform line length

[ ] Document contains no uniform line length

[ ] Pages have uniform number of lines

[ ] Pages do not have uniform number of lines

[ ] Pages are left justified

[ ] Pages are right justified

[ ] Pages are full justified

Specified keywords are: [ ]

Document contains [ ] number of pages

[ ] Pages are numbered

[ ] Paragraphs are numbered

[ ] Document contains queries

[ ] Document contains lists

[ ] Document contains tables

[ ] Document contains charts

[ ] Document contains graphics

[ ] Document has standardized margins

[ ] Document has a date

[ ] Document has several dates

[ ] Document has a telephone number

[ ] Document has more than one telephone number

[ ] Document has no telephone numbers

Having specified a set of format and content characteristics, the user can save these document features under a name (e.g., form, correspondence, paper, article, advertisement). The system reference this look-up table in the document type identification process. Data format characteristics are evaluated using the system's image screening tools which map the pattern of the data in an underlying *.TIFF image. File content characteristics are evaluated by computer-aided document profiling processes which locate specified keywords and determine the correlation between the keyword set located in the document and the keyword reference lexicon in the system's document type identification files.

To Generate a File Characterization

For purposes of this discussion, a file characterization is considered to be a computerized report that contains a document type component and a document subject component. A document type might be, for example, “form”. A document subject might be, for example, “legal”. A file characterization for document that exhibits these characteristics would be a “legal/form”.

To generate a file characterization, the user would activate the document type identification routines and the document subject identification routines.

To Generate Document Profiles

For purposes of this discussion, a document profile is considered to be a computerized report that contains a document type component, a document subject component, and a critical content component. A document type might be, for example, “form”. A document subject might be, for example, “legal”. A critical content component might include, for example, names mentioned, keywords, and dates. A document profile for document that exhibits these characteristics would be a “legal/form/King George, John Hancock, George Washington, Thomas Jefferson, John Adams'/ Jul. 2, 1776/independent, equal”.

To generate a file characterization, the user would activate document type identification routines, document subject identification routines, and data mining routines.

To Output to a Database

The system automatically writes the values of the fields in each document profile to a standard database. This database can be imported to most commonly used document management/information retrieval systems.

While there are given above certain specific examples of this invention and its application in practical use, it should be understood that they are not intended to be exhaustive or to be limiting of the invention. On the contrary, these illustrations and explanations herein are given in order to acquaint others skilled in the art with this invention and the principles thereof and a suitable manner of its application in practical use, so that others skilled in the art may be enabled to modify the invention and to adapt and apply it in numerous forms each as may be best suited to the requirement of a particular use.

We claim:

1. A method of analyzing an electronic text document using a knowledge bank, said knowledge bank being formed of a plurality of lexicons, said method comprising the steps of:
defining for each of said lexicons an associated subject header;
defining a list of word terms having a logical relationship with said subject header; and
analyzing said electronic documents using said plurality of lexicons.
